(19) United States
(12) Patent Application Publication
(10) Pub. No.: US 2026/0236485 A1
(43) Pub. Date: Aug. 13, 2026

(54) Implementing Concurrency Safety Via Deferred Synchronization of Divergent Mutations

(71) Applicant: Oracle International Corporation, Redwood Shores, CA (US)

(72) Inventor: Erik Österlund, Vasterhaninge (SE)

(73) Assignee: Oracle International Corporation, Redwood Shores, CA (US)

(21) Appl. No.: 19/539,354

(22) Filed: Feb. 13, 2026

Related U.S. Application Data
(60) Provisional application No. 63/758,232, filed on Feb. 13, 2025.

(51) Int. Cl. G06F 16/27; G06F 9/52

(52) U.S. Cl. CPC G06F 16/27; G06F 9/522; G06F 9/526

(57) ABSTRACT

Techniques for concurrency management are disclosed. The system implements concurrency safety by lazily synchronizing divergent mutations to separate copies of shared data structures and tracking the progression of this synchronization process through colored pointers. The system synchronizes divergent mutations to separate copies of a shared data structure by generating a new copy of this shared data structure that merges these mutations. The system generates a new copy of a shared data structure if and when the new copy is a basis for resuming program execution. At the start of the synchronization process, the system defines a new, good color for pointers that refer to these new copies. When a pointer is updated to refer to a new copy of a shared data structure instead of a preexisting copy of the shared data structure, the system stores the good color in the pointer to track the progression of the synchronization process.

### INCORPORATION BY REFERENCE; DISCLAIMER

Each of the following applications and any parent patent applications (provisionals, non-provisionals, international, and foreign) to which this application claims priority to, directly or indirectly, are hereby incorporated by reference in their entirety to the same extent as if fully and explicitly recited herein. Any incorporation by reference is limited such that no subject matter is incorporated that is contrary to the explicit disclosure herein. The applications being incorporated by reference include at least: U.S. Application No. 63/758,232 filed on Feb. 13, 2025.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to concurrent computing architectures. In particular, the present disclosure relates to implementing concurrency safety in concurrent computing environments.

### BACKGROUND

With respect to a computing architecture, the term “concurrency” refers to the ability of a computing system to perform multiple tasks simultaneously and/or the ability of the computing system to perform multiple tasks in overlapping time periods. As used herein, the term “task” refers to one or more related computing operations. Performing tasks concurrently can improve the efficiency and performance of a computing system. However, concurrency can also give rise to an issue that results from one task interfering with another task that is being performed concurrently (referred to herein as a “concurrency issue”). Example concurrency issues include data races, nondeterministic behavior, memory corruption, lost updates, livelock, deadlock, resource starvation, priority inversion, thread thrashing, undefined program behavior, security risks, and others.

A concurrency issue can result from conflicting accesses to the same location in memory. For example, if two threads of execution are concurrently performing tasks that involve accessing the same shared data structure and if one of the threads is attempting to mutate this shared data structure, a concurrency issue may arise. As used herein, the term “shared data structure” refers to a data structure accessible to multiple independent processes and/or subcomponents of processes. A runtime object is an example of a data structure that may exist in runtime memory, and a shared object (i.e., a shared, runtime object) is an example of a shared data structure. Conversely, the term “private data structure” refers to a data structure that is not accessible to multiple independent processes and/or subcomponents of processes. The verb “mutate” refers to changing the state of a data structure, and the noun “mutator” refers to a process and/or a subcomponent of that process that is attempting to mutate a data structure. A thread of execution that writes a new value to a data structure is an example of a mutator. The term “thread of execution” is used herein to identify a subcomponent of a process. For brevity, a thread of execution may be referred to herein simply as a “thread.” Two threads that access a shared data structure in a conflicting manner may be constituents of the same process, or those two threads may be constituents of two different processes. In the example context of multiple threads collaboratively executing the same program instance, conflicting accesses to the same memory location are often the result of a causality bug in the program instance. A program may, for example, include a causality bug if a programmer fails to correctly establish or maintain the relationship between cause and effect in the logic of the program.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced in accordance with one or more embodiments;

FIG. 2 is a block diagram illustrating one embodiment of a computer system suitable for implementing methods and features described herein in accordance with one or more embodiments;

FIG. 3 illustrates an example virtual machine memory layout in block diagram form in accordance with one or more embodiments;

FIG. 4 illustrates an example frame in block diagram form in accordance with one or more embodiments;

FIG. 5 illustrates a system for practicing techniques described herein in accordance with one or more embodiments;

FIG. 6 illustrates an example set of operations for initiating a process for synchronizing divergent mutations to copies of a data set in accordance with one or more embodiments;

FIG. 7 illustrates an example set of operations for lazily synchronizing divergent mutations to copies of a data set in accordance with one or more embodiments;

FIG. 8A, FIG. 8B, FIG. 8C, and FIG. 8D illustrate the impact of an example set of operations for synchronizing divergent mutations to copies of a data set in accordance with an example embodiment; and

FIG. 9 is a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURES
   2.2 EXAMPLE VIRTUAL MACHINE ARCHITECTURE
   2.3 LOADING, LINKING, AND INITIALIZING
3. CONCURRENCY MANAGEMENT SYSTEM
4. MANAGING CONCURRENT COMPUTING OPERATIONS
   4.1 INITIATING A SYNCHRONIZATION PROCESS
   4.2 LAZILY SYNCHRONIZING DIVERGENT MUTATIONS
5. EXAMPLE EMBODIMENT
6. PRACTICAL APPLICATIONS, ADVANTAGES, AND IMPROVEMENTS
7. HARDWARE OVERVIEW
8. MISCELLANEOUS; EXTENSIONS

### 1. General Overview

One or more embodiments implement concurrency safety by lazily synchronizing divergent mutations that have been applied to separate copies of a data set while tracking the progression of this lazy synchronization process by coloring pointers that refer to these copies of the data set. For example, the system may synchronize one set of mutations that have been applied to one copy of the data set with a different set of mutations that have been applied to another copy of the data set. The data set may include shared data structures, private data structures, and/or other types of data structures. In synchronizing divergent mutations that have been applied to copies of the data set, the system generates a new copy of the data set that merges the divergent mutations. Performing an operation “lazily” refers herein to deferring the performance of this operation at least until the outcome of this operation is identified as a necessary or preferred basis for performing some other operation. In an example, the system delays synchronizing a pair of divergent mutations that have been respectively applied to two separate copies of the same shared data structure until synchronizing this pair of divergent mutations is a requisite or ideal input for continuing normal program execution. For instance, in this example, the system may delay synchronization until a new copy of the shared data structure that merges these divergent mutations is needed to complete a request from a program instance. As used herein, the term “pointer” refers to a set of bits that is allocated, at least in part, for storing an address of a memory location, and the phrase “coloring a pointer” refers to embedding metadata into bit(s) within this pointer that are not being utilized to store an address of a memory location. For example, after generating a new copy of a shared data structure by merging divergent mutations that have been applied to other copies of the shared data structure, the system may remap a pointer that formerly referred to one of these other copies of the shared data structure, so this pointer now refers to the new copy of the shared data structure, and the system may color this pointer to indicate that this pointer is confirmed to refer to the correct memory location as part of the this synchronization process.

One or more embodiments implement concurrency safety by compelling independent processes or threads to interact with shared data structures indirectly through isolated copies of these shared data structures. For instance, rather than permitting a thread to directly interact with shared data structures while completing tasks at the behest of a program instance, the system may compel the thread to create copies of these shared data structures that are inaccessible to other threads, and the system may redirect execution of these tasks by the thread to operate on these isolated copies rather than the actual shared data structures. By redirecting the execution of these tasks to operate on the isolated copies, the system may avoid concurrency issues that could otherwise arise if the thread executed these tasks directly on the shared data structures while another thread was concurrently manipulating these same shared data structures. Redirecting the execution of a task targeting one copy of a data structure to instead operate on another copy of this data structure may be referred to herein as “staging” the performance of this task. A copy of data structure that is created for staging the performance of a task may be referred to herein as a “staged copy” of this data structure. Additionally, a mutation that is applied to a staged copy of a data structure while staging the performance of a task may be referred to herein as a “staged mutation.”

One or more embodiments implement concurrency safety by synchronizing divergent mutations that have been respectively applied to an original copy of a shared data structure and a staged copy of this data structure. For instance, in response to certain events, conditions, and/or other stimuli, the system may direct a thread to begin synchronizing (a) any staged mutations that the thread has applied to the thread's current staged copies of shared data structures with (b) any mutations that have been applied to the actual shared data structures by other threads. As used herein, the term “synchronization trigger” refers to an event, condition, and/or other stimuli that triggers a synchronization process. If there are no conflicts between the divergent mutations, then the system directs the thread to create a new staged copy of the shared data structures that merges the divergent mutations. After creating the new staged copy of the shared data structures, the system may permit the thread to update the actual shared data structures to match the state of the new staged data structure if it is safe to do so. On the other hand, if a staged mutation applied to a staged copy of a shared data structure conflicts with a mutation applied to the actual shared data structure, then the system may (a) direct the thread to abort synchronization, (b) discard the thread's current staged copies of the shared data structures, (c) create another staged copy of the shared data structures that matches the current state of the actual shared data structures, and (d) restart the task that previously created the conflict. In synchronizing the staged mutations that have been applied to the thread's current staged copies of the shared data structure with any mutations that have been applied to the actual shared data structure, the system directs the thread to create a new staged copy of the shared data structures that merges these mutations.

One or more embodiments implement concurrency safety by directing a thread to remap pointers while synchronizing (a) any staged mutations that have been applied to the thread's staged copies of shared data structures with (b) any mutations that have been applied to the actual shared data structure by other threads. For instance, when the thread encounters a pointer that still refers to an old staged copy of a shared data structure after a new staged copy of this shared data structure has been created as part of the current synchronization process, the system may direct the thread to remap this pointer to the new staged copy. By directing the thread to remap this pointer to the new staged copy, the system may ensure that the thread applies subsequent staged mutations to the new staged copy rather than the old staged copy while performing tasks at the behest of a program instance.

One or more embodiments implement concurrency safety by directing a thread to lazily synchronize (a) any staged mutations that have been applied to the thread's staged copies of shared data structures with (b) any mutations that have been applied to the actual shared data structures by other threads. As noted above, the system may direct a thread to synchronize any staged mutations that the thread has applied to a staged copy of a shared data structure with any mutations that have been applied to the actual shared data structure by other threads by creating a new staged copy of the shared data structure that merges these divergent mutations. Thus, while performing this synchronization process (referred to hereafter as “the present synchronization process”), the thread is creating new staged copies of the shared data structures. However, note that replacing the totality of the old staged copies with corresponding new staged copies during the present synchronization process may be unnecessary. Creating a new staged copy of a shared data structure during the present synchronization process may be unnecessary if this new staged copy is not needed by the thread to stage the performance of a task before the present synchronization process is concluded. For example, if a new staged copy of a shared data structure is not needed by the thread to stage the performance of a task before another synchronization trigger initiates a new synchronization process for the thread, then there may be no need to create a new staged copy of this shared data structure during the present synchronization process. Needlessly creating a new staged copy of a shared data structure during the present synchronization process may constitute an unnecessary expenditure of computing resources. Therefore, to avoid unnecessary operational overhead that may be detrimental to program performance, the system lazily performs the present synchronization process. In particular, the system directs the thread to create a new staged copy of a shared data structure during the present synchronization process if and when this new staged copy becomes a necessary or preferred basis for continuing normal program execution while maintaining concurrency safety. By directing the thread to lazily create new staged copies of shared data structures in this manner, the system minimizes the operational overhead associated with implementing concurrency safety via staging the performance of tasks.

One or more embodiments implement concurrency safety by directing a thread to synchronize divergent mutations to separate copies of shared data structures and lazily remap pointers that refer to outdated copies of these shared data structures. As noted above, when the thread encounters a pointer that still refers to an old staged copy of a shared data structure after a new staged copy of shared data structure has been created as part of this synchronization process, the system may direct the thread to remap this pointer to the new staged copy. However, note that performing a traversal of runtime memory to locate and remap a pointer that refers to an old staged copy of a shared data structure may constitute an unnecessary expenditure of computational resources if the thread is never instructed to dereference this pointer while performing tasks at the behest of a program instance during this synchronization process. Therefore, to avoid unnecessary operational overhead that may be detrimental to program performance, the system directs the thread to lazily remap pointers that refer to old staged copies of shared data structures. For example, if the thread creates a new staged copy of a shared data structure, and if the thread is subsequently instructed to load a pointer that refers to an old staged copy of this shared data structure while performing a task at the behest of a program instance, then the system may direct the thread to remap this pointer to the new staged copy before proceeding with the task. By directing the thread to lazily remap pointers in this manner, the system minimizes the operational overhead associated with implementing concurrency safety via staging the performance of tasks.

While lazily synchronizing divergent mutations to separate copies of shared data structures and lazily remapping pointers that refer to outdated copies of these shared data structures, one or more embodiments direct a thread to track the progression of this lazy synchronization process by coloring these pointers. When this lazy synchronization process is initiated, the system directs the thread to define a new good color for tracking the progression of the lazy synchronization process. As used herein, the term “color” refers to a value that is encoded into bit(s) of a pointer not being utilized to store an address of a memory location, and the term “good color” refers to a color encoded into a pointer to affirmatively indicate the presence of at least one state characteristic. By defining the new good color for tracking the progression of the lazy synchronization process, the thread renders a color that was used for tracking the progression of a previous synchronization process into a bad color. Therefore, in the instant after the thread defines the new good color, any given pointer that refers to an old staged copy of a shared data structure that corresponds to the previous synchronization process can be expected to include the bad color or no color. Whenever the thread is directed to load a pointer that includes the bad color or no color while performing tasks at behest of a program instance, the system directs the thread to “heal” this pointer. To heal a pointer that includes a bad color, the thread determines if this pointer currently refers to the correct memory location. If this pointer currently refers to an old staged copy of a shared data structure, then this pointer should be remapped to a new staged copy of this shared data structure since the program instance is currently instructing the thread to load this pointer to access the memory location that is referenced by this pointer. If the new staged copy has not yet been created during this lazy synchronization process, then the system directs the thread to create the new staged copy at this time. After creating the new staged copy or confirming that the new staged copy has already been created, the system directs the thread to remap the pointer to the new staged copy. When remapping the pointer to the new staged copy, the system directs the thread to store the new good color in this pointer to indicate that this pointer has been confirmed to refer to the correct memory location as part of this lazy synchronization process. After remapping and recoloring the pointer, the pointer is now healed, and the system may permit the thread to proceed with program execution as normal. If the program instance subsequently instructs the thread to load this pointer again during the lazy synchronization process, the thread can assume that this pointer correctly refers to a new staged copy of a shared data structure based on the pointer, including the new good color. Since the thread can assume that this pointer correctly refers to a new staged copy of a shared data structure, the thread need not repeat any of the checks that were previously performed by the thread while healing this pointer. As a result, the computational overhead that would be associated with repeating these checks is avoided. Furthermore, the thread can make this assumption at minimal cost because the information that is the basis for this assumption (i.e., the new good color being encoded into the pointer) is already being accessed by the thread while loading the pointer at the behest of the program instance. In this way, the system minimizes the operational overhead associated with lazily creating new staged copies of shared data structures and lazily remapping pointers.

One or more embodiments described in this Specification and/or recited in the Claims may not be included in this General Overview section.

### 2. Architectural Overview

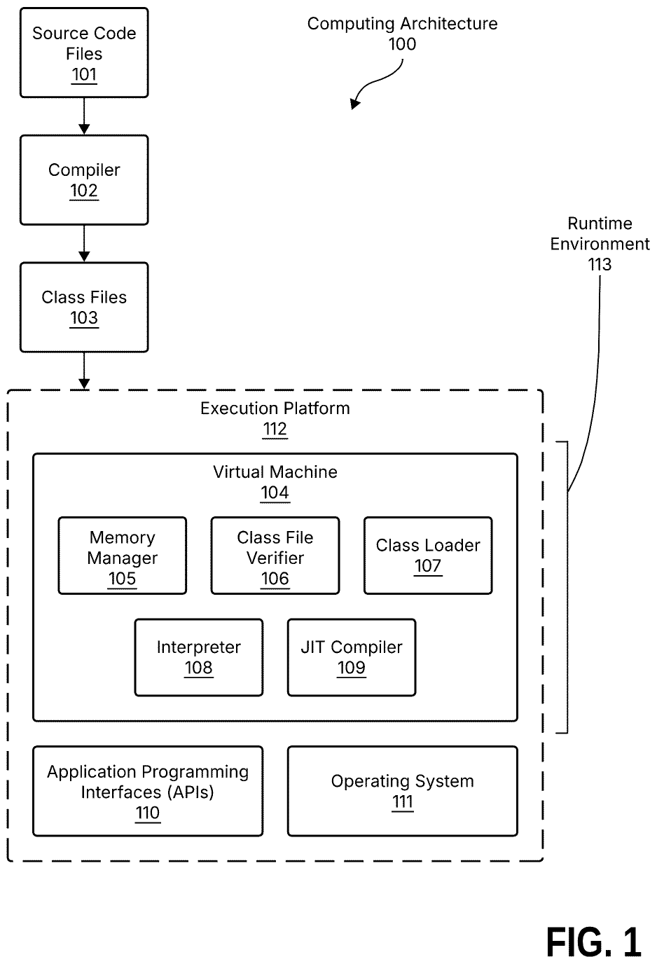

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that include code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 include the virtual machine instructions that have been converted from the source code files 101. However, in other embodiments, the class files 103 may include other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages”, each of which includes a collection of classes that provide related functionality. For example, a library may include one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class Files Structure

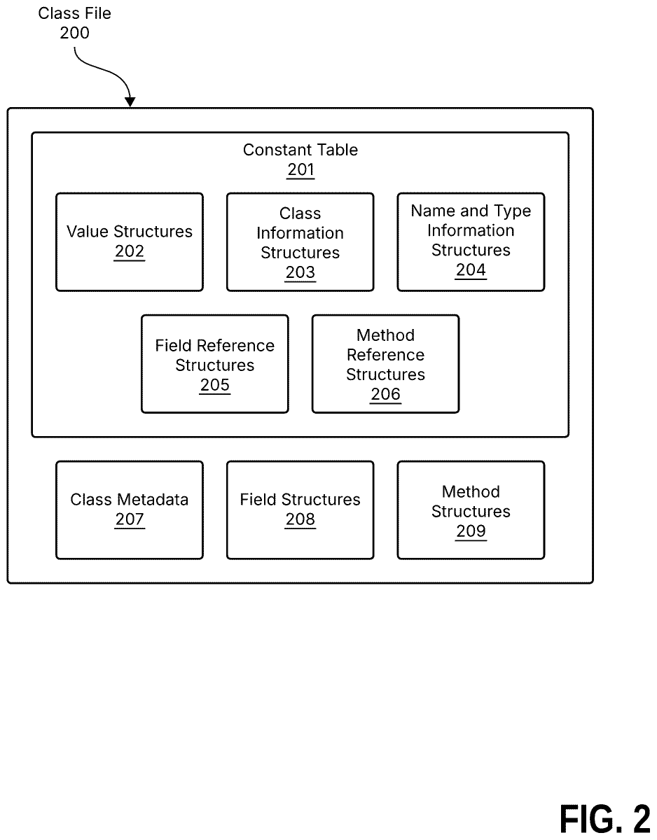

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference; thus, “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m(int I, double d, Thread t) { . . . }” matches the descriptor “(ID L Thread) L Object”.

In an embodiment, the virtual machine instructions held in the method structures 209 include operations which reference entries of the constant table 201. Using Java as an example, consider the following class:

```
class A
{
  int add12and13( ) {
    return B.addTwo(12, 13);
  }
}
```

In the above example, the Java method add12and13 is defined in class A, takes no parameters, and returns an integer. The body of method add12 and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I)I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references”. One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

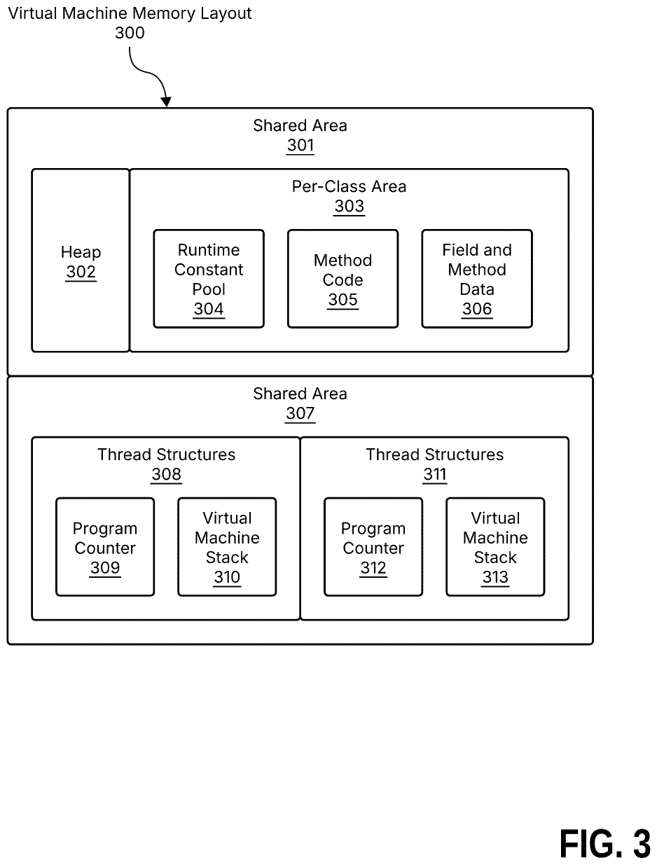

FIG. 3 illustrates an example virtual machine memory layout 300 in block diagram form according to an embodiment. To provide clear examples, the remaining discussion will assume that the virtual machine 104 adheres to the virtual machine memory layout 300 depicted in FIG. 3. In addition, although components of the virtual machine memory layout 300 may be referred to as memory “areas”, there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per-class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

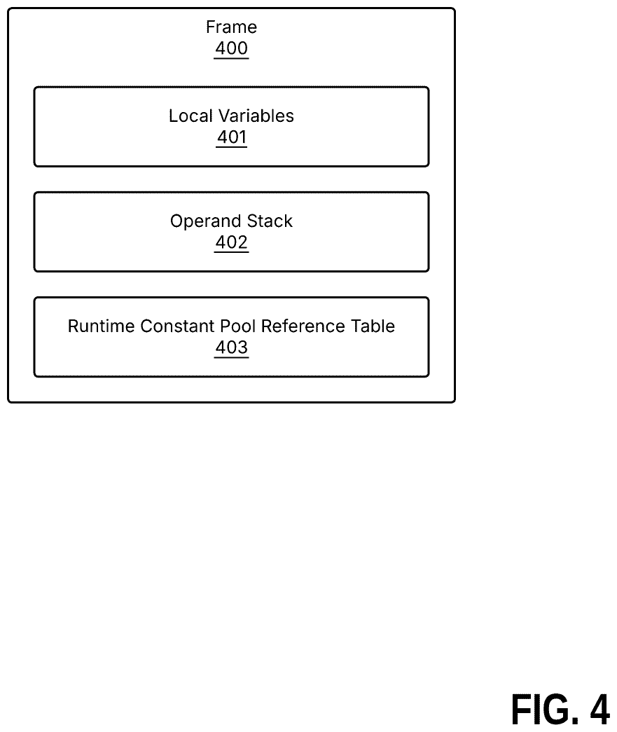

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 includes a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded but does not necessarily require those classes to also be linked before proceeding. For example, assume Class A contains a reference to a static field of Class B. During verification, the virtual machine 104 may check Class B to ensure that the referenced static field exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. Concurrency Management System

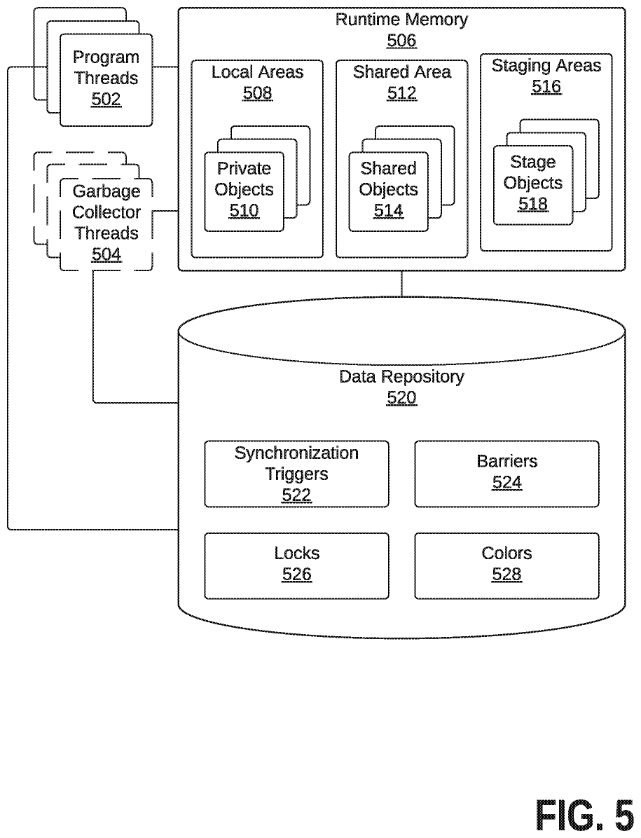

FIG. 5 illustrates a system 500 for practicing techniques described herein in accordance with one or more embodiments. As illustrated in FIG. 5, system 500 may include program threads 502, garbage collector threads 504, runtime memory 506, and data repository 520. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

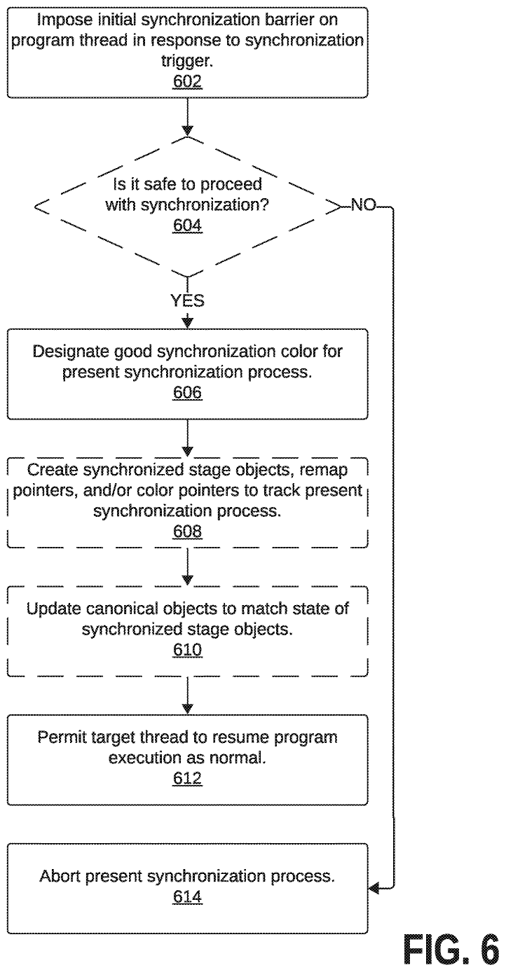

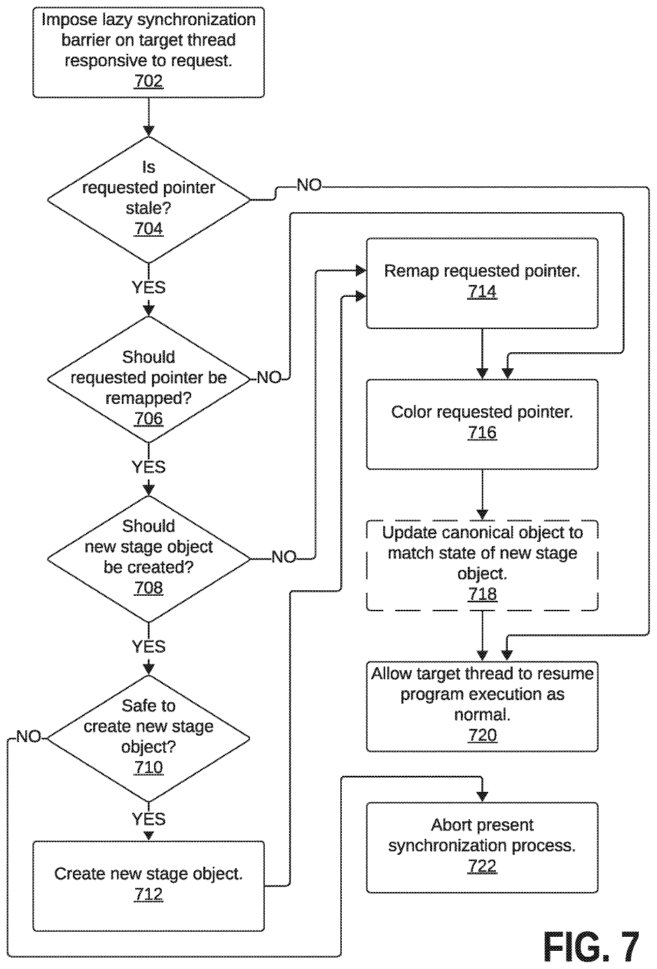

In one or more embodiments, system 500 refers to software and/or hardware configured for managing concurrent computing operations. In this way, system 500 is configured to prevent, detect, diagnose, and/or resolve concurrency issues. Example operations for managing concurrent computing operations are described below with reference to FIG. 6 and FIG. 7.

In an embodiment, system 500 is implemented in a computing environment that includes multiple threads of executions. As noted above, a thread of execution or thread, such as a program thread 502 or a garbage collector thread 504, is a subcomponent of a process. A thread may serve as an independent execution environment for executable instructions. A multi-thread computing environment is an example of a computing environment that can perform concurrent operations. A typical implementation of the Java Runtime Environment is one example of a multi-thread computing environment. The implementation of system 500 as a threaded computing environment is described herein for illustrative purposes and is not intended to define any limits to this disclosure. A threaded computing environment is neither essential nor necessary to practice the techniques described herein. The techniques described herein are equally applicable to other computing architectures. In general, the techniques described herein are applicable to any computing architecture that can perform concurrent computing operations. The techniques described herein are applicable to both centralized computing systems and distributed computing systems.

In one or more embodiments, a program thread 502 refers to a thread of execution generally allocated to perform tasks at the behest of a program instance. A task that is performed at the behest of a program instance is referred to herein as a “program task.” Note that completing some program tasks may require manipulating information residing in runtime memory 506. For instance, while completing the requests of a program instance, a program thread 502 may be creating new data structures within runtime memory 506, reading from data structures residing in runtime memory 506, writing to data structures residing in runtime memory 506, and/or performing various other operations within runtime memory 506. In addition to program tasks, a program thread 502 may be configured to perform other tasks. For example, a program thread 502 may be configured to perform concurrency management tasks, garbage collection tasks, and/or other tasks. A program thread 502 may be configured to perform tasks other than program tasks through the imposition of barriers 524.

In one or more embodiment, a garbage collector thread 504 refers to a thread of execution generally allocated to perform tasks at the behest of a garbage collection process. As used herein, the term “garbage collection” refers generally to memory management, and the term “garbage collection task” refers to a task performed at the behest of a garbage collection process. In the example context of system 500, a garbage collection process may be configured to reclaim memory allocated to data structures residing within runtime memory 506 that are no longer needed by a currently executing program instance. In some embodiments, system 500 excludes dedicated garbage collector threads 504 because garbage collection tasks are delegated to program threads 502. In other words, in some embodiments, there may be no distinction between a program thread 502 and a garbage collector thread 504. As used herein, the term “garbage collector” refers to any thread performing a garbage collection task. As noted above, both program threads 502 and garbage collector threads 504 may perform garbage collection tasks. Thus, the term “garbage collector” may refer to a program thread 502, a garbage collector thread 504, or another thread.

In one or more embodiments, runtime memory 506 refers to a data repository that includes memory space allocated for the use of at least one program instance during runtime. For example, runtime memory 506 may include data structures, such as shared data structures and private data structures, generated by program threads 502 during program execution. In addition to including information that can be manipulated by a program thread 502 at the behest of a program instance, runtime memory 506 may include information that is not exposed at a program level. For example, runtime memory 506 may include data structures and/or references to data structures that cannot be accessed by a program thread 502 while that program thread 502 is actively executing executable instructions for a program instance. Note that in this example, these data structures that are not exposed at a program level may be accessible to the program thread 502 if and when the program thread 502 is not actively performing program tasks. For instance, in this example, data structures that are generally inaccessible to a program thread 502 while actively performing program tasks may be accessible to the program thread 502 while actively performing concurrency management tasks and/or garbage collection tasks. As illustrated in FIG. 5, runtime memory 506 may be organized into various areas, such as local areas 508, a shared area 512, staging areas 516, and/or other areas. Additionally, or alternatively, runtime memory 506 may be organized into generations and/or other logical or physical subdivisions. For example, runtime memory 506 may be organized into a young generation and an old generation. Runtime memory 506 may be implemented on any type of storage unit and/or device (e.g., a file system, database, collection of tables, or any other storage mechanism) for storing data. Furthermore, runtime memory 506 may be implemented on multiple different storage units and/or devices. The multiple different storage units and/or devices may or may not be of the same type or located at the same physical site. Runtime memory 506 may be implemented in volatile memory, and/or runtime memory 506 may be implemented in persistent memory.

In an embodiment, runtime memory 506 is implemented in the context of one or more class-based, object-oriented programming languages. Examples of class-based, object-oriented programming languages include Java, C++, C#, Python, Ruby, and others. The implementation of runtime memory 506 in the context of class-based, object-oriented program language(s) is described herein for illustrative purposes and is not intended to define any limits to the present disclosure. A class-based, object-oriented programming language is neither essential nor necessary to practice the techniques described herein. The techniques described herein are equally applicable to other data structures, other computing environments, and other programming languages.

In an embodiment, information is represented within runtime memory 506 by runtime objects. A runtime object is a data structure that exists in memory during program execution (i.e., runtime). An example runtime object is an instance of a reference type such as a class. A runtime object may be conceptualized as a higher-level abstraction of binary data that resides somewhere in low-level memory. For example, a runtime object may be an abstraction of binary data stored to main memory (e.g., random access memory (RAM)) or a cache (e.g., a thread-local cache). In the example that is illustrated by FIG. 3, runtime memory 506 may be implemented, in whole or in part, within heap 302. As illustrated in FIG. 5, runtime memory 506 may include private objects 510, shared objects 514, stage objects 518, and/or other types of runtime objects.

In an embodiment, a runtime object, such as a private object 510, a shared object 514, or a stage object 518, includes direct-write field(s) and/or non-direct-write field(s). As noted above, the term “direct-write field” refers to a field whose value is generally (a) written directly to main memory and (b) read directly from main memory. For example, if a value is written to a direct-write field, a thread will generally not be permitted to delay storing that value in main memory in favor of performing some other program task. In comparison, if a value is written to a non-direct-write field, a thread may delay storing that value in main memory, and that value may reside in a cache, such as a thread-local cache, while storage of this value to main memory is being delayed. While a value stored to a direct-write field is generally not permitted to languish in a cache while storage to main memory is postponed, note that a value that is written to a direct-write field may temporarily reside in a cache during the process of storing that value to main memory. For example, a value written to a direct-write field may be temporarily stored in a cache to preserve visibility guarantees while that value is being stored to main memory. In general, the implementation of direct-write fields may vary between embodiments. For example, with respect to Java, a direct-write field may be implemented using the “volatile” keyword; in contrast, with respect to C or C++, a direct-write field may be implemented using the “std::atomic” tokens.

In an embodiment, runtime memory 506 is subject to at least one garbage collection process during runtime. For example, during runtime, a garbage collection process may be configured to reclaim memory space allocated to runtime objects residing in runtime memory 506. In this example, the garbage collection process may classify memory space allocated to a runtime object as being eligible for reclamation if that runtime object has become less than strongly reachable. A runtime object is generally considered strongly reachable if there is at least one chain of strong reference(s) that can be traversed by at least one program thread 502 to access that runtime object at the behest of a program instance. The term “strong reference” refers to a reference that (a) fully participates in a reachability analysis performed by a garbage collector and (b) is not subjected to the collection rules that are applied to specialized references, such as soft references, weak references, phantom references, and so on. If there is no chain of strong reference(s) that can be traversed by a program thread 502 to access a runtime object at the behest of a program instance, that runtime object will generally not be considered strongly reachable. Note that a runtime object being less than strongly reachable to a program thread 502 does not necessarily imply that the runtime object is unreachable to that program thread 502. For example, a runtime object that is not strongly reachable may remain reachable through a non-strong reference. Furthermore, the term “unreachable” is not necessarily synonymous with the term “inaccessible.” For example, a runtime object that is unreachable to a program thread 502 may remain accessible to a garbage collector thread 504. As used herein, the term “disposable” identifies information eligible for garbage collection, and the term “live” identifies information ineligible for garbage collection. While strongly reachable objects are generally live objects, note that the term “live” is not interchangeable with “strongly reachable.” For example, runtime objects that are less than strongly reachable, such as softly reachable objects, may be live objects in at least some cases. In other embodiments, runtime memory 506 is not subjected to a separate garbage collection process during runtime. For example, in these other embodiments, disposable information may be deallocated by threads while executing the executable instructions of a program instance.

In one or more embodiments, a local area 508 refers to a section of runtime memory 506 that is generally allocated for the private data structures of a specific program thread 502. For example, a local area 508 of a program thread 502 may include information inaccessible to other program threads 502 while those program threads 502 are actively performing program tasks. A corresponding local area 508 may exist for any given program thread 502. As illustrated in FIG. 5, a local area 508 may include private objects 510 and/or other data structures.

In one or more embodiments, a private object 510 refers to a runtime object that (a) a program instance can interact with through a single program thread 502 and (b) is not a stage object 518. If a runtime object is a private object 510, there is a single program thread 502 that can access that runtime object at the behest of a program instance; no other program thread 502 can obtain a traversable reference to that runtime object while performing a program task. As noted above, some forms of “reachability” do not coincide with accessibility. Thus, a runtime object that is reachable to multiple program threads 502 may nonetheless be a private object 510. Note that the use of the word “private” as an adjective in the term “private object” does not refer to a private accessor flag. A private object 510 does not necessarily include a private field. In many cases, a private object 510 includes no private fields. Generally, a runtime object is initially a private object 510 when that runtime object is instantiated; after being instantiated, a private object 510 may become a shared object 514.

In one or more embodiments, shared area 512 refers to a section of runtime memory 506 that is generally allocated for storing information accessible to multiple program threads 502. In other words, shared area 512 is generally used for storing information exposed to multiple program threads 502. As illustrated in FIG. 5, shared area 512 may include shared objects 514 and/or other data structures.

In one or more embodiments, a shared object 514 refers to a runtime object that a program instance can interact with through multiple program threads 502. Generally, a program instance is able to interact with a runtime object through a program thread 502 if there is at least one chain of references leading to the runtime object that can be traversed by the program thread 502 while executing the program instance. Note that some references, such as phantom references, cannot be traversed by a program thread 502 while executing a program instance. As noted above, multiple conflicting accesses to a shared object 514 may give rise to a concurrency issue. For example, two accesses to a shared object 514 conflict if (a) those two accesses are performed in furtherance of two separate tasks being performed concurrently and (b) at least one of those tasks is attempting to mutate the shared object 514. If the two conflicting accesses are allowed to occur in this example, a data race may occur. However, note that conflicting accesses do not necessarily result in a data race or another concurrency issue. It should also be noted that, in some cases, two accesses to a shared object 514 may conflict even if both of those two accesses are reading from the shared object 514 and not mutating the shared object 514.

In one or more embodiments, a staging area 516 refers to a section of runtime memory 506 allocated for storing at least one staged copy of a data set. In general, a staging area 516 may be configured to serve as memory space dedicated for staging the performance of a task on a data set. A staging area 516 may include a single staged copy of a single data set, multiple staged copies of a single data set, or multiple staged copies of multiple data set. A staged copy of a data set that is included in a staging area may be accessible to no program threads 502, a single program thread 502, or multiple program threads 502. A data set that is staged in a staging area 516 typically includes at least one data structure such as a runtime object. As illustrated in FIG. 5, staging areas 516 may include stage objects 518. Additionally, or alternatively, staging areas 516 may include staged copies of other data structures.

In an embodiment, a staging area 516 is exposed to a subset of the program threads 502 that share access to runtime memory 506. In an example, a staging area 516 is exposed to a single program thread 502, and other program threads 502 are unable to access information residing in this staging area 516 while performing program tasks. In other words, this staging area 516 is isolated from the other program threads 502 in this example.

In an embodiment, a staging area 516 is configured to serve as an isolated section of runtime memory 506 where a program thread 502 is permitted to access shared, non-volatile information. For example, within a staging area 516, a program thread 502 may be permitted to read from and/or write to non-direct-write fields of runtime objects instantiated in the staging area 516. In this embodiment, a program thread 502 may be prevented from directly accessing shared, non-volatile information that resides outside of a staging area 516.

In an embodiment, multiple staging areas 516 are allocated for a single program thread 502. The multiple staging areas 516 may correspond to different staged copies of a data set. A staging area 516 that includes the most recent staged copy of a data set accessible to a program thread 502 may be referred to herein as this program thread's 502 “current staging area,” and a program thread 502 may be referred to herein as being “based” in the program thread's 502 current staging area.

In one or more embodiments, a stage object 518 refers to a staged copy of a runtime object. For example, a stage object 518 may be a staged copy of a private object 510, a staged copy of a shared object 514, or a staged copy of another type of runtime object. A staged copy of a runtime object (i.e., a stage object 518) may include values copied from the runtime object, other staged copies of the runtime object, and/or other memory locations. As an example, consider a stage object 518 that is a staged copy of a shared object 514. In this example, the stage object 518 may include values copied from the shared object 514, copies of the shared object 514, and/or other memory locations. As used herein with respect to a staged copy of a particular object (i.e., a stage object 518), the term “canonical object” refers to the particular object. For example, if a stage object 518 is a staged copy of a shared object 514, then this shared object 514 is the stage object's 518 corresponding canonical object. Similarly, with respect to a staged copy of a particular data structure, the term “canonical data structure” refers here to the particular data structure. As used herein, the term “canonical data set” refers to a copy of a data set that includes at least one canonical data structure. Note that the state of one staged copy of a runtime object may differ from the state of another staged copy of this same runtime object. Furthermore, the state of a stage object 518 may differ from the state of the corresponding canonical object. It should also be noted that in the instant after the state of a canonical object is updated to match the state of a corresponding stage object 518, the precise state of the canonical object may still differ from the state of the corresponding stage object 518. For example, a direct-write field in a stage object 518 may be configured differently than the same direct-write field in a corresponding canonical object even in the instant after the state of the canonical object is updated to match the state of the stage object 518.

In one or more embodiments, a data repository 520 is any type of storage unit and/or device (e.g., a file system, database, collection of tables, or any other storage mechanism) for storing data. Furthermore, a data repository 520 may include multiple different storage units and/or devices. The multiple different storage units and/or devices may or may not be of the same type or located at the same physical site. Furthermore, a data repository 520 may be implemented or executed on the same computing system as other components of system 500. Additionally, or alternatively, a data repository 520 may be implemented or executed on a computing system separate from other components of system 500. A data repository 520 may be communicatively coupled to other components of system 500 via a direct connection or via a network. As illustrated by FIG. 5, a data repository 520 may include information describing synchronization triggers 522, barriers 524, locks 526, and colors 528. Information describing synchronization triggers 522, barriers 524, locks 526, and colors 528 may be implemented across any of the components within system 500. However, this information is illustrated within a data repository 520 for purposes of clarity and explanation.

In one or more embodiments, a synchronization trigger 522 refers to an event, condition, and/or other stimuli that triggers a synchronization process. For instance, a synchronization trigger 522 may precipitate an attempt to synchronize divergent mutations applied to separate copies of a data set. In general, the events, conditions, and/or stimuli that will amount to synchronization triggers 522 may vary between embodiments. Example events, conditions, and/or other stimuli that may be synchronization triggers 522 include an attempt to access a direct-write field, an attempt to access a final field, a program task defined using a synchronized keyword, a program task defined using an atomic keyword, a program task that involves accessing a memory location through a var handle, a joining of threads, a termination of a thread, a garbage collection task that requires synchronization of runtime memory, and others.

In an embodiment, a synchronization trigger 522 causes an attempt to synchronize (a) any mutations that have been applied to a canonical data set with (b) any mutations that have been applied to at least one staged copy of the data set. For example, a synchronization trigger 522 may initiate an attempt to synchronize (a) any mutations that have been applied to a set of shared objects 514 with (b) any mutations that have been applied to staged copies of these shared objects 514 (i.e., stage objects 518).

In an embodiment, a synchronization trigger 522 is explicitly represented in the executable instructions of a program instance. For example, a synchronization trigger 522 may be a request by a program instance for performance of a program task by a program thread 502.

In an embodiment, a synchronization trigger 522 is an attempt to access a direct-write field. For example, a synchronization trigger 522 may be a request by a program instance for performance of a program task that involves reading from and/or writing to a direct-write field of a runtime object.

In an embodiment, a synchronization trigger 522 is a request from a program instance for performance of a program task defined in source code with a specific token. Example tokens that may be configured to trigger a synchronization process include a synchronized keyword, an atomic keyword, and others. In general, the tokens configured to trigger synchronization processes may vary between embodiments.

In an embodiment, a synchronization trigger 522 is a request by a program instance for performance of a program task that involves accessing a memory location using an access mechanism associated with memory ordering semantics. For example, a synchronization trigger 522 may be a request by a program instance for performance of a program task that involves accessing a memory location using a var handle.

In an embodiment, a synchronization trigger 522 is not explicitly represented in the executable instructions of a program instance. For example, a synchronization trigger 522 may be a termination of a thread, a joining of threads, an attempt by a garbage collection process to synchronize threads during a garbage collection cycle, or some other occurrence not necessarily explicitly represented within the executable instructions of the program instance.

In one or more embodiments, a barrier 524 refers to an additional set of executable instructions inserted into, or proximate to, executable instructions for completing a task. For example, while converting class files 103 of a program into machine-level code, JIT compiler 109 may insert barriers 524 into the machine-level instructions that correspond to the program tasks to be performed by a program thread 502. A barrier 524 is referred to herein as being “imposed” on a thread when the thread is actively performing the executable instructions defined in the barrier 524. Barriers 524 may be imposed on program threads 502, and/or barriers 524 may be imposed on garbage collector threads 504. By imposing a barrier 524 on a program thread 502 that is completing requests of a program instance, system 500 may direct the program thread 502 to perform tasks other than program tasks. Example barriers 524 that may be imposed on a thread include load barriers, store barriers, and others.

In an embodiment, a barrier 524 is a load barrier. As used herein, the term “load barrier” refers to a barrier 524 imposed on a thread in response to the thread being instructed to perform a load operation. An example load operation is a request by a program instance for a program thread 502 to load a pointer that refers to a runtime object. An example load barrier defines operations that a program thread 502 should perform before and/or after a load operation that triggers the imposition of the example load barrier.

In an embodiment, a barrier 524 is a store barrier. As used herein, the term “store barrier” refers to a barrier 524 imposed on a thread in response to the thread being instructed to perform a store operation. An example store operation is a request by a program instance for a program thread 502 to write a value to a location in memory such as an object field of a runtime object. An example store barrier defines operations that a program thread 502 should perform before and/or after a store operation.

In an embodiment, a barrier 524 includes executable instructions for facilitating a synchronization process. For example, a barrier 524 may include executable instruction for initiating a synchronization process and/or lazily synchronizing divergent mutations to separate copies of a data set during the synchronization process. As used herein, the term “synchronization barrier” refers to any barrier 524, including executable instruction for facilitating a synchronization process. A synchronization barrier may be a load barrier, a store barrier, or another variety of barrier. A synchronization barrier that includes executable instructions for initiating a synchronization process may be referred to herein as an “initial synchronization barrier.” An initial synchronization barrier may be imposed on a thread in response to a synchronization trigger 522. Examples operation that may be performed while executing an initial synchronization barrier are described below with reference to FIG. 6. A synchronization barrier that includes executable instructions for lazily synchronizing divergent mutations to separate copies of a data set during a synchronization process may be referred to herein as a “lazy synchronization barrier.” Examples operations that may be performed while executing a lazy synchronization barrier are described below with reference to FIG. 7. A barrier 524 may be configured as both an initial synchronization barrier and a lazy synchronization barrier. Additionally, or alternatively, an initial synchronization barrier and a lazy synchronization barrier may be implemented as different barriers 524.

In an embodiment, a barrier 524 includes executable instructions for performing a concurrency check. As noted above, a concurrency check is a check for potential concurrency issues and/or causality bugs. Example mechanisms that may be leveraged by a barrier 524 to perform a concurrency check include object graphs, event tracing, execution tracing, Lamport timestamps, vector clocks, hybrid logical clocks, timestamps, read/write counters, locks 526, data-flow analysis, and others.

In an embodiment, a barrier 524 includes executable instructions for detecting conflicting mutations to separate copies of a data set (i.e., a concurrency check). For example, during a synchronization process, a barrier 524 may instruct a thread to determine if any mutations that have been applied to a canonical object conflict with any mutations that have been applied to a stage object 518. As used herein, the term “canonized mutation” refers to a mutation applied to a canonical data structure, and the term “staged mutation” refers to a mutation applied to a staged copy of a canonical data structure.

In an embodiment, a barrier 524 includes executable instructions for failure handling. For example, if a concurrency check performed during a synchronization process reveals a conflict between a canonized mutation and a staged mutation, a barrier 524 may direct a thread to (a) abort the synchronization process, (b) restart the program task that triggered the synchronization process, (c) flag the conflict to a user as a manifestation of a causality bug, (d) terminate a program instance, and/or (e) perform other corrective actions.

In an embodiment, a barrier 524 includes executable instructions for creating a new staged copy of a data set. For example, during a synchronization process, a barrier 524 may instruct a thread to create a staged copy of a canonical object (referred to herein as a “synchronized stage object”) by synchronizing (a) any mutations that have been applied to the canonical object with (b) any mutations that have been applied to a preexisting staged copy of the canonical object (referred to herein as an “unsynchronized stage object”).

In an embodiment, a barrier 524 includes executable instructions for rebasing a program thread 502. As used herein, the term “rebasing” refers to (a) allocating a new staging area 516 for a program thread 502 and/or (b) creating a new staged copy of a data set in the new staging area 516. In an example, a barrier 524 instructs a program thread 502 to rebase itself during a synchronization process. In another example, a barrier 524 instructs a program thread 502 to rebase itself while restarting a program task after a concurrency check revealed a conflict mutation resulting from a previous attempt to complete this program task.

In an embodiment, a barrier 524 includes executable instructions for remapping a pointer. As noted above, a pointer is a set of bits that is at least partially allocated for storing an address of a memory location. As used herein, the term “address bits” refers to the bit(s) of a pointer allocated for storing an address of a memory location. Note that pointer may include more bits than are needed to store an address of a memory location. In general, a pointer may be remapped by updating the address bits of the pointer. In an example, a barrier 524 includes executable instructions for remapping a pointer that refers to an unsynchronized stage object, so this pointer instead refers to a synchronized stage object.

In an embodiment, a barrier 524 includes executable instructions for consulting a forwarding table. As used herein, the term “forwarding table” refers to mapping(s) between copies of a data structure. For instance, a forwarding table may map a synchronized stage object to an unsynchronized stage object and/or a canonical object. In an example, a barrier 524 directs a thread to consult a forwarding table to determine if a pointer that refers to a stage object 518 requires remapping.

In an embodiment, a barrier 524 includes executable instructions for updating a forwarding table. For example, after a synchronized stage object has been created, a barrier 524 may direct a thread to update a forwarding table to include an entry that maps the synchronized stage object to an unsynchronized stage object and/or a canonical object.

In an embodiment, a barrier 524 includes executable instructions for coloring a pointer. In other words, a barrier 524 may include executable instructions for embedding metadata into bits within a pointer that are not being utilized to store an address of a memory location. As used herein, the term “non-address bits” refers to bit(s) of a pointer not being utilized to store an address of a memory location. In an example, a barrier 524 includes executable instructions for storing a color 528 into the non-address bits of a pointer and/or stripping a color 528 from the non-address bits of a pointer.

In an embodiment, a barrier 524 includes executable instruction for designating the color 528 that should be used for coloring the non-address bits of a pointer. For example, a barrier 524 may include executable instructions for designating what color 528 should be stored to the synchronization bits of a pointer to track the progression of a synchronization process.

In an embodiment, a barrier 524 includes executable instructions for performing garbage collection tasks. A barrier 524 may include executable instructions for performing garbage collection tasks directed to private objects 510, shared objects 514, stage objects 518, and/or other data structures.

In one or more embodiments, a lock 526 refers to a mechanism for controlling access to a memory location. For example, a lock 526 may be used to restrict access to a shared object 514. If a thread holds a lock 526 on a shared object 514, other threads may be prevented from manipulating that shared object 514 if the thread retains the lock 526 on the shared object 514. Example locks 526 that may be utilized to restrict access to a memory location include mutex locks, read-write locks, spinlocks, re-entrant locks, semaphore locks, and others.

In one or more embodiments, a color 528 refers to a value encoded into non-address bit(s) of a pointer. A color 528 may be encoded into non-address bits of a pointer to record state information associated with the pointer. For example, the coloring of a pointer may reflect the state of the pointer, the state of a data structure referenced by the pointer, the state of a data structure that includes the pointer, and/or state information. The state information described by the coloring of a pointer may be consumed by lower-level processes that facilitate program execution. For example, the state information recorded by the coloring of a pointer may be used to support concurrency safety, garbage collection, memory relocation, and other runtime management tasks. Note that coloring a pointer to record state information associated with the pointer may be advantageous with respect to computational efficiency because this state information can be accessed as part of reading the pointer itself without the need for any additional load operations beyond the loading of the pointer.

In an embodiment, a color 528 is designated as indicating specific state characteristic(s) when stored to a set of non-address bit(s) within a pointer. For instance, a set of non-address bit(s) in a pointer may be allocated for describing specific state characteristic(s), and a specific color 528 may be defined to indicate the presence or absence of these specific state characteristic(s) when stored to this set of non-address bits in the pointer. In an example, a set of non-address bits in a pointer is allocated for indicating if it has been confirmed that this pointer currently refers to the correct memory location. In another example, a set of non-address bits in a pointer is allocated for indicating if a runtime object referenced by the pointer is reachable, and another set of non-address bits in this pointer is allocated for indicating if this runtime object is strongly reachable. As used herein, “a set of coloring bits” refers to non-address bit(s) in a pointer allocated for describing specific state characteristic(s). A set of coloring bits may encode a good color, a bad color, or no color. With respect to a set of coloring bits allocated for describing a state characteristic, a “good color” refers to a color 528 that can be encoded to this set of coloring bits to affirmative indicate the presence of this state characteristic, and a “bad color” refers to any color 528 other than a good color. As an example, consider a set of coloring bits in a pointer that is allocated for indicating if it has been confirmed that this pointer refers to the correct address. If this set of coloring bits includes a good color in this example, then any thread that loads this pointer can assume that this pointer does in fact refer to correct memory location. However, note that the inverse is not necessarily true in this example. For instance, in this example, the presence of the bad color in this set of coloring bits does not necessarily indicate that this pointer refers to the wrong memory location. Instead, the presence of a bad color or no color in this set of coloring bits may indicate that it has not yet been confirmed that this pointer refers to the correct memory location in this example. If a set of coloring bits included in a pointer encodes a bad color or no color, then this pointer may be referred to herein as a “stale pointer.” Conversely, a pointer may be referred to as “healed” when the pointer is not stale. Note that the value that is considered a good color for one set of coloring bits may be different than the value that is considered a good color for another set of coloring bits. It should also be noted that the value considered to be the good color for a set of coloring bits may change. For example, a thread may define a new value as the good color for a set of coloring bits. When the new value is defined as the good color for the set of coloring bits in this example, the value that was previously considered to be the good color for this set of coloring bits becomes a bad color for this set of coloring bits. The current good color for a set of coloring bits in a pointer may be recorded in a memory location that is readily accessed to a thread that may encounter this pointer, and a thread may designate a new good color for this set of coloring bits by storing a new value to this memory location. In an example, the current good color for a set of coloring bits is encoded into a barrier 524, stored to a global storage mechanism, stored to a thread-local storage mechanism, and/or maintained in another memory location.

In an embodiment, a color 528 may be encoded into a pointer to reflect the progression of a synchronization process. For example, a pointer may include a set of coloring bits allocated for indicating if this pointer refers to the correct memory location, and a new color may be designated for this set of coloring bits at the start of a synchronization process. Note that during a synchronization process, a new staged copy of a data structure may be created, and a pointer that refers to an older staged copy of the data structure may need to be remapped to the new staged copy to ensure that outdated information is not returned to a program instance. A set of coloring bits that may be used to track the progression of a synchronization process with respect to a pointer may be referred to herein as “synchronization bits” of the pointer. A value designated as a good color for the synchronization bits of a pointer may be referred to herein as a “good synchronization color.” In an example, the absence of a good synchronization color from the synchronization bits of a pointer indicates that this pointer may require healing. If this pointer does not refer to an unsynchronized stage object 518 in this example, then healing the pointer may simply entail storing the good synchronization color to the synchronization bits of the pointer. However, if the pointer does refer to an unsynchronized stage object 518 in this example and if a synchronized stage object 518 has not yet been created to replace the unsynchronized stage object 518, then healing the pointer may also entail creating the synchronized stage object 518, remapping the pointer to the synchronized stage object 518, updating a forwarding table, and/or other operations. Conversely, in this example, the presence of a good synchronization color in the synchronization bits of the pointer indicates that this pointer has been confirmed to refer to the correct memory address since the beginning of an ongoing synchronization process associated with this pointer. Furthermore, in this example, if the pointer refers to a stage object 518, then presence of the good synchronization color in the synchronization bits further indicates that this stage object 518 is a synchronized stage object 518 that has been created during the ongoing synchronization process.

In an embodiment, system 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. Managing Concurrent Computing Operations

FIG. 6 and FIG. 7 illustrate example operations for managing concurrent computing operations in accordance with one or more embodiments. In an embodiment, the operations illustrated in FIG. 6 and FIG. 7 are performed in a multi-thread computing environment implemented in the context of at least one object-oriented programming language; to provide a cohesive explanation and consistent examples, the remainder of this Section 4 shall assume the same. However, neither a multi-thread computing environment nor an object-oriented programming language are essential or necessary to practice the techniques described herein. The techniques described herein are equally applicable to other concurrent computing architectures and other programming languages.

### 4.1 Initiating a Synchronization Process

FIG. 6 illustrates an example set of operations for initiating a synchronization process in accordance with one or more embodiments. One or more operations illustrated in FIG. 6 may be modified, rearranged, or omitted. Accordingly, the sequence of operations illustrated in FIG. 6 should not be construed as limiting the scope of one or more embodiments.

In one or more embodiments, the system identifies a synchronization trigger, and the system imposes an initial synchronization barrier on a program thread in response to the synchronization trigger (Operation 602). As noted above, a synchronization trigger is an event, condition, and/or other stimuli that triggers a synchronization process. A program thread is a thread of execution that is generally allocated for executing at least part of a program instance. Additionally, an initial synchronization barrier includes executable instructions for initiating a synchronization process. Here, the initial synchronization barrier includes executable instructions for initiating a process for synchronizing divergent mutations to copies of a data set. For instance, the initial synchronization barrier may include executable instructions for (a) checking for potential concurrency issues associated with synchronizing divergent mutations to copies of the data set, (b) synchronizing some or all these divergent mutations, (c) tracking the progression of this synchronization process, and/or (d) facilitating other operations for program execution. Hereafter, the program thread subjected to the initial synchronization barrier is referred to as “the target thread,” and the synchronization process that may be initiated and/or performed by the target thread while executing the initial synchronization barrier is referred to as “the present synchronization process.” Note that other synchronization processes involving the same data set as the present synchronization process may have occurred prior to the present synchronization process. Furthermore, it should also be noted that other synchronization processes associated with other data sets and other program threads may be ongoing at this time.

In an embodiment, some or all the operations illustrated in FIG. 6 may be performed by the target thread while executing the initial synchronization barrier; to provide a cohesive explanation and consistent example, the remainder of this Subsection 4.1 shall assume the same. In other embodiments, executable instructions for some or all the operations illustrated in FIG. 6 may be defined in other barriers, defined outside of barrier logic, and/or executed by other threads.

In an embodiment, the system imposes the initial synchronization barrier on the target thread in response to a request from the program instance to the target thread for performance of a specific program task. In other words, in this embodiment, the synchronization trigger is the program instance's request to the target thread for performance of this specific program task; to provide a cohesive explanation and consistent examples, the remainder of this Subsection 4.1 shall assume the same. Hereafter, the specific task, defined in the program instance's request amounting to the synchronization trigger, is referred to simply as “the program task.” In an example, completing the program task entails reading from and/or writing to a direct-write field. In this example, the program instance's request to read from and/or write to this direct-write field while completing the program task is the synchronization trigger, and the system inserts the barrier into or proximate to the executable instructions for reading from and/or writing to this direct-write field. In another example, the program task entails reading from and/or writing to a final field (i.e., the synchronization trigger). In yet another example, the program task is defined in source code with a synchronized keyword, an atomic keyword, or some other special keyword or token designated as a synchronization trigger. In yet another example, the source code of the program task directs the target thread to access some location in memory using a var handle or some other access mechanism that may be associated with memory ordering semantics. In other embodiments, the synchronization trigger is not explicitly defined in executable instructions of the program instance. For example, in these other embodiments, the synchronization trigger may be a termination of a thread, a joining of threads, an attempt by a garbage collection process to synchronize threads during a garbage collection cycle, or some other event not necessarily explicitly represented within executable instructions of the program instance.

In an embodiment, the present synchronization process is directed to synchronizing divergent mutations to copies of a set of runtime object(s). Hereafter, this set of runtime object(s) is referred to as “the target objects.” In particular, in this embodiment, the present synchronization process is directed to synchronizing (a) any mutations that have been applied to one copy of the target objects that resides in a shared area and/or a local area of the target thread with (b) any mutations that have been applied to a staged copy of the target objects that resides in a staging area of the target thread; to provide a cohesive explanation and consistent examples, the remainder of this Subsection 4.1 shall assume the same. In other embodiments, the present synchronization process involves more than two copies of the target objects, and/or the present synchronization process involves copies of the target objects that reside in other memory locations. Hereafter, the copy of the target objects residing in the shared area and/or the target thread's local area is referred to as “the canonical objects;” the target thread's current staging when the initial synchronization barrier is imposed on the target thread is referred to as “the initial staging area;” and the staged copy of the target objects residing in the initial staging area is referred to as “the unsynchronized stage objects.” Generally, it can be expected that, at some point in the past, the state of the canonical objects was broadly consistent with the state of the unsynchronized stage objects at the program level. Note that even when fully synchronized, the state of the canonical objects may somewhat differ from the state of the unsynchronized stage objects, depending on how these two copies of the target objects are implemented and/or isolated in runtime memory. Hereafter, the state of runtime memory at the most recent point in time when the state of the canonical objects was broadly consistent with the state of the unsynchronized stage objects is referred to as “the last ancestor state.” At present, the state of the canonical objects may still be broadly consistent with the state of the unsynchronized stage objects. For example, the state of the canonical objects may still be broadly consistent with the state of the unsynchronized stage objects if neither the canonical objects nor the unsynchronized stage objects have been mutated in the time that has elapsed since the unsynchronized stage objects were first created in the initial staging area. Alternatively, the state of the canonical objects may have diverged from the state of the unsynchronized stage objects since the last ancestor state. For example, in the time that has elapsed since the last ancestor state, the target thread may have mutated the unsynchronized stage objects and/or other threads may have mutated the shared canonical objects.

In one or more embodiments, the target thread, acting pursuant to the barrier, may determine if it is safe to initiate the present synchronization process, and the target thread may proceed to another operation based on this determination (Operation 604). The target thread may determine if it is safe to proceed with the present synchronization process by performing concurrency check(s). As noted above, a concurrency check is a check for potential concurrency issues and/or causality bugs. The target thread performs no concurrency check, a single concurrency check, or multiple concurrency checks. If the initial synchronization barrier does not direct the target thread to perform a concurrency check, then the target thread proceeds to Operation 606. Similarly, if the target thread fails to identify a potential concurrency issue associated with initiating the present synchronization process while performing a concurrency check defined in the initial synchronization barrier, then target thread proceeds to Operation 606. In these scenarios, the target thread will proceed with the present synchronization process. On the other hand, if the target thread does identify a potential concurrency issue and/or causality bug associated with the present synchronization process while performing a concurrency check defined in the initial synchronization barrier, then the target thread proceeds to Operation 614. In this scenario, the target thread will abort the present synchronization process.

In an embodiment, the target thread, acting pursuant to the initial synchronization barrier, determines if it is safe to initiate the present synchronization process (i.e., performs a concurrency check) by comparing (a) any mutations that have been applied to at least a subset of the canonical objects to (b) any mutations that have been applied to the corresponding unsynchronized stage objects since the last ancestor state. Hereafter, any mutation(s) applied to the canonical objects since the last ancestor state are referred to as “the canonized mutations,” and any mutation(s) applied to the unsynchronized stage objects since the last ancestor state are referred to as “the staged mutations.” The target thread performs this comparison to determine if any canonized mutations conflict with any staged mutations. In other words, the target thread is determining if the canonized mutations are compatible with the staged mutations. In an example, the target thread determines if the canonized mutations are compatible with the staged mutations by comparing (a) the fields of the canonical objects that have been updated by the canonized mutations with (b) the fields of the unsynchronized objects that have been updated by the staged mutations. If the fields updated by the canonized mutations do not overlap with the fields updated by the staged mutations, then the target thread may conclude that the canonized mutations are compatible with the staged mutations. Alternatively, if there is at least one field that is updated by both the canonized mutations and the staged mutations, then the target thread may conclude that the canonized mutations are not compatible with the staged mutations.

In an embodiment, the target thread lazily synchronizes the canonized mutations with the staged mutations while executing the initial synchronization barrier. For example, while executing the initial synchronization barrier, the target thread may refrain from synchronizing a canonized mutation with a staged mutation if synchronizing these divergent mutations is not necessary to resume program execution. As a result, the target thread may synchronize a subset of the divergent mutations while executing the initial synchronization barrier. If the target thread synchronizes a subset of divergent mutations, then the target thread may also refrain from checking for conflicts between divergent mutations that will not be synchronized by the target thread while executing the initial synchronization barrier.

In one or more embodiments, the target thread, acting pursuant to the initial synchronization barrier, designates a new good color for the present synchronization process (Operation 606). Hereafter, the new good color the present synchronization process is referred to as “the good synchronization color.” The target thread designates a value as the good synchronization color by storing this value in at least one memory location used for tracking the current good color for the synchronization bits of pointers associated with the target thread. For example, the good synchronization color may be encoded into synchronization barriers, stored in global storage mechanisms, stored in thread-local storage mechanisms, and/or defined in other memory locations. As noted above, the synchronization bits of a pointer are a set of coloring bit (i.e., non-address bit(s) allocated for describing state information) for which a new good color is defined when initiating a synchronization process. As discussed in greater detail below, the good synchronization color can be used to track the present synchronization process with respect to a pointer by selectively storing the good synchronization color to the synchronization bits of the pointer. By defining a new good color for the synchronization bits of a pointer, the target thread may render another color, previously considered a good color for the synchronization bits of the pointer, into a bad color. For example, a color previously used to track the progression of a prior synchronization process involving the unsynchronized stage objects may now be considered a bad color. Thus, in the instant after the good synchronization color is defined in this example, it can be expected that the synchronization bits of any given pointer that refers to an unsynchronized stage object will either include a bad color or no color. Note that in addition to the synchronization bits, a pointer may include other sets of coloring bits reserved for describing other state characteristics, and the colors considered good for these other sets of coloring bits may be different than the good synchronization color. It should also be noted that good synchronization color may be specific to the present synchronization process. For example, there may be another ongoing synchronization process involving the stage objects of another thread. In this example, the color considered good for the synchronization bits in a pointer that refers to a stage object of the other thread may be different than the good synchronization color.

In one or more embodiments, the target thread, acting pursuant to the initial synchronization barrier, may (a) create new staged copy(s) of target object(s) in a staging area of the target thread, (b) remap pointers, and/or (c) color these pointers to track the progression of the present synchronization process (Operation 608). Hereafter, any new staged copy(s) of target object(s) created in a staging area of the target thread during the present synchronization process are referred to as “the synchronized stage objects.” In some cases, the target thread may not create synchronized stage objects at this time (i.e., skip this operation). In other cases, the target thread creates synchronized stage objects for a subset of the target objects, or the target thread creates synchronized stage objects for the totality of the target objects. In general, the synchronized stage objects created at this time may vary depending on (a) whether or not the initial synchronization barrier directs the target thread to eagerly or lazily create synchronized stage objects, (b) if and what synchronized stage objects are needed to resume program execution, (c) if and what concurrency checks have been performed thus far, and/or (d) other factors. In creating the synchronized stage objects, the target thread establishes a new version of the target objects. In an embodiment, another staging area is allocated to the target thread for the synchronized stage objects. In other words, the target thread rebases itself from the initial staging area to the other staging area while creating the synchronized stage objects in this embodiment; to provide a cohesive explanation and consistent examples, the remainder of this Subsection 4.1 shall assume the same. Hereafter, the other staging area created for the synchronized stage objects is referred to as “the new staging area.” In other embodiments, the target thread does not rebase itself to another staging area. For example, in these other embodiments, the target thread may create synchronized stage objects by updating the unsynchronized stage objects.

In an embodiment, the target thread lazily creates a synchronized stage object while executing the initial synchronization barrier. For example, while executing the initial synchronization barrier, the target thread may refrain from creating synchronized stage objects that are not needed to resume program execution at this time. In an example, the target thread creates the synchronized stage objects that will be accessed while performing the program task, and the target thread refrains from creating other synchronized stage objects that will not be accessed while completing the program task. Note that creating a synchronized stage object may be unnecessary if that synchronized stage object is not needed to complete a program task in the time that elapses until another synchronization process is initiated in a staging area of the target thread. By lazily creating synchronized stage objects, the system may avoid the computational cost associated with creating synchronized stage objects not needed for program execution. In another embodiment, the target thread eagerly creates the synchronized stage objects.

In an embodiment, the target thread, acting pursuant to the initial synchronization barrier, creates a synchronized stage object by synchronizing (a) any mutations that have been applied to the corresponding canonical object since the last synchronization with (b) any mutations that have been applied to the corresponding unsynchronized stage object since the last synchronization. While creating a synchronized stage object (i.e., a new staged copy of a target object), the target thread may pull values from the corresponding canonical object, the corresponding unsynchronized stage object, and/or other copies of the target object. As an example, consider a particular field that will be included in a synchronized stage object. If the canonized mutations of this example updated the canonized version of this particular field (i.e., the version of this particular field included in the corresponding canonical object), then the target thread may select the value that is held by the canonical version of this particular field for inclusion in the new staged version of this particular field (i.e., the version of this particular field that will be included in the corresponding synchronized stage object). If the staged mutations of this example updated the initial staged version of this particular field (i.e., the version of this particular field included in the corresponding unsynchronized stage object), then the target thread may select the value held by the initial staged version of this particular field for inclusion in the new staged version of this particular field. If neither the canonized mutations nor the staged mutations updated a version of the particular field in this example, then the target thread may pull the value held by the canonized version of this particular field, the new staged version of this particular field, or another version of this particular field.

In an embodiment, the target thread, acting pursuant to the initial synchronization barrier, remaps a pointer that refers to an unsynchronized stage object, so this pointer instead refers to the corresponding stage object. For example, if the target thread creates a synchronized stage object and if the target thread encounters a pointer that refers to the corresponding unsynchronized stage object, then the target thread may remap this pointer to the synchronized stage object. In this example, the target thread remaps the pointer by updating the address bits in the pointer to describe the memory location of the synchronized stage object.

In an embodiment, the target thread, acting pursuant to the initial synchronization barrier, colors a pointer to indicate that this pointer refers to the appropriate memory location following the start of the present synchronization process. Recall that the target thread previously defined a new good color for the synchronization bits of pointers to stage objects of the target thread (i.e., the good synchronization color). Further recall that as a result of defining the good synchronization color, it can be expected that in the instant after the good synchronization color is defined, the synchronization bits of any given pointer that refers to an unsynchronized stage object will either include a bad color or no color. When remapping a pointer so that the pointer refers to a synchronized stage object, the target thread stores the good synchronization color to the synchronization bits of this pointer. Note that based on the synchronization bits of a pointer storing the good synchronization color, any thread that subsequently encounters the pointer can assume that this pointer refers to the appropriate memory location following the start of the present synchronization process. The target thread may color pointers held by runtime objects, and the target thread may color pointers that reside outside of heap memory such as roots.

In one or more embodiments, the target thread may update the canonical objects to match the state of the synchronized stage objects (Operation 610). In other words, the target thread may commit the new version of the target objects to the shared area and/or the local area of the target thread. In an embodiment, the target thread may not update the canonical objects whenever a new version of the target objects is established in a staging area. In this embodiment, the target thread may periodically or selectively skip this operation. In another embodiment, the target thread may update the canonical objects whenever a new version of the target objects is established, and the target thread will generally not skip this operation.

In an embodiment, the target thread acquires a lock on a canonical object that resides in the shared area of runtime memory (i.e., a shared object) before updating this canonical object to match the state of a corresponding synchronized stage object. By acquiring a lock on a shared object, the target thread ensures that no other thread can mutate that shared object while the target thread holds the lock. In this way, the target thread may prevent concurrency issues that could otherwise arise due to another thread concurrently attempting to commit other changes to shared memory.

In one or more embodiments, the initial synchronization barrier permits the target thread to resume program execution as normal (Operation 612). In this scenario, the initial synchronization barrier permits the target thread to resume program execution as normal because the target thread has successfully initiated the present synchronization process, and the target thread may perform the program task on any synchronized stage objects that were created while the target thread was executing the initial synchronization barrier. Note that the present synchronization process may not be complete at this time. In other words, the present synchronization process may still be ongoing. For example, the target thread may have only created synchronized stage objects for a subset of the target objects while executing the initial synchronization barrier, and the target thread may subsequently lazily create other synchronized stage objects while executing other synchronization barriers that are subsequently imposed on the target thread.

In one or more embodiments, the target thread, acting pursuant to the initial synchronization barrier, aborts the present synchronization process (Operation 614). In this scenario, the initial synchronization barrier calls for the termination of the present synchronization process because the target thread uncovered a potential concurrency issue and/or causality bug associated with synchronizing the canonized mutations and the staged mutations. For example, the target thread may have identified a canonized mutation to a field in a canonical object that conflicts with a staged mutation to that same field in an unsynchronized stage object. Additionally, or alternatively, the initial synchronization barrier may direct the target thread to perform other corrective actions. Examples of other corrective actions that may be stipulated by the initial synchronization barrier include preventing or delaying the completion of the program task, alerting a user to the potential concurrency issue and/or causality bug, discarding the unsynchronized stage objects, creating a new staged copy of the canonical objects to replace the unsynchronized stage objects, restarting the program task, terminating the program instance, and others.

In an embodiment, the target thread, acting pursuant to the initial synchronization barrier, flags a conflict between a canonized mutation and a staged mutation as manifestation of a causality bug in the program instance. The target thread flags this conflict as a manifestation of a causality bug even if this conflict was unlikely to result in any evident concurrency issue. As is discussed below, consistently flagging manifestations of causality bugs even where these manifestations are unlikely to cause a concurrency issue may aid in diagnosing this causality bug.

In an embodiment, the target thread, acting pursuant to the initial synchronization barrier, discards the unsynchronized stage objects and creates a new staged copy of the canonical objects. The target thread creates this new staged copy of the canonical objects by copying from the canonical objects. The staged mutations are not applied to this new staged copy of the canonical objects. After creating the new staged copy of the canonical objects, the initial synchronization barrier instructs the target thread to restart the program task defined in the program instance's request.

### 4.2 Lazily Synchronizing Divergent Mutations

FIG. 7 illustrates an example set of operations for lazily synchronizing a data set in accordance with one or more embodiments. One or more operations illustrated in FIG. 6 may be modified, rearranged, or omitted. Accordingly, the sequence of operations illustrated in FIG. 6 should not be construed as limiting the scope of one or more embodiments.

In one or more embodiments, the system identifies a request from a program instance to a program thread that may warrant lazily synchronizing the data set, and the system imposes a lazy synchronization barrier on the program thread in response to this request (Operation 702). As noted above, a lazy synchronization barrier includes executable instructions for conditionally continuing an ongoing synchronization process. Here, the initial synchronization barrier is imposed on this program thread because the program instance's request instructs the program thread to perform some tasks that may involve reading from, writing to, or otherwise interacting with the data set. The lazy synchronization barrier may be a load barrier, a store barrier, and/or another type of barrier. Hereafter, the program thread subjected to the lazy synchronization barrier is referred to as “the target thread;” the synchronization process that may be continued by target thread while executing the lazy synchronization barrier is referred to as “the present synchronization process;” and the task that the program instance is instructing the target thread to perform is referred to as “the program task.” The present synchronization process was previously initiated by the target thread or another thread. For example, the target thread may have previously initiated the present synchronization process while executing an initial synchronization barrier.

In an embodiment, the present synchronization process is directed to synchronizing divergent mutations to copies of a set of runtime object(s). Hereafter, this set of runtime object(s) is referred to as “the target objects.” In particular, in this embodiment, the present synchronization process is directed to synchronizing (a) any mutations that have been applied to a copy of the target objects residing in a shared area and/or a local area of the target thread with (b) any mutations that have been applied to a staged copy of the target objects that predates the present synchronization process; to provide a cohesive explanation and consistent examples, the remainder of this Subsection 4.2 shall assume the same. Hereafter, the copy of the target objects residing in the shared area and/or the target thread's local area is referred to as “the canonical objects,” and the staged copy of the target objects that predates the present synchronization process is referred to as “the unsynchronized stage objects.” The unsynchronized stage objects may reside in a single staging area of the target thread, or the unsynchronized stage objects may be distributed between multiple staging areas of the target thread. Note that there may be multiple staged copies of a target object. The unsynchronized stage objects will generally include the most recent staged copy of a target object that predates the present synchronization process. The present synchronization process is attempting to create a new staged copy of the target objects that merges the divergent mutations with the canonical objects and the unsynchronized stage objects. Note that the present synchronization process may end before a full copy of the target objects is created. Hereafter, the new staged copy of the target objects that merges the divergent mutations to the canonical objects and the unsynchronized stage objects is referred to as “the synchronized stage objects.” During the present synchronization process, the target thread rebases itself into a new staging area where the synchronized stage objects are created, or the target thread creates the synchronized stage objects in a preexisting staging area.

In an embodiment, completing the program task involves accessing a runtime object (referred to hereafter as “the requested object”) by loading a pointer that refers to the requested object (referred to hereafter as “the requested pointer”); to provide a cohesive explanation and consistent examples, the remainder of this Subsection 4.2 shall assume the same. In addition, completing the program task may entail reading from the requested object, writing to the requested object, other interactions with the requested object, and/or other interactions with the requested pointer. The requested object may or may not be a target object. In an example of the latter scenario, the requested pointer is held by a stage object, and the requested object is a private object for which a staged copy need not be created for staging the performance of the program task. If the requested object is a target object, then the requested object may or may not have already been synchronized during the present synchronization process. For example, if the requested object is a target object, then a new staged copy of the requested object may have already been created in a staging area of the target thread (i.e., a synchronized stage object) during the present synchronization process (i.e., the requested object has been synchronized), or it may be that a new staged copy of the requested object has not yet been created in a staging area of the target thread during the present synchronization process (i.e., the requested object is unsynchronized).

In an embodiment, the lazy synchronization barrier is a load barrier. As noted above, a load barrier is a barrier imposed on a thread in response to the thread being instructed to perform a load operation. For example, the lazy synchronization barrier may be imposed on the target thread in response to the program instance's request instructing the target thread to load the requested pointer. In another embodiment, the lazy synchronization barrier is a store barrier. As noted above, a store barrier is a barrier imposed on a thread in response to the thread being instructed to perform a store operation. For example, the lazy synchronization barrier may be imposed on the target thread in response to the program instance's request instructing the target thread to update a field of the requested object.

In one or more embodiments, the target thread, acting pursuant to the lazy synchronization barrier, determines if the requested pointer is stale with respect to the present synchronization process, and the target thread proceeds to another operation based on this determination (Operation 704). As noted above, a pointer is stale if a set of coloring bits in the pointer includes a bad color or no color. Here, the target thread determines if the requested pointer is stale with respect to the present synchronization process by inspecting the synchronization bits of the requested pointer. As noted above, the synchronization bits of a pointer are a set of coloring bits (i.e., non-address bit(s) allocated for describing state information) for which a new good color is defined when initiating a synchronization process. If the synchronization bits store a value, then the target thread may determine if this value is a bad color by comparing this value to the current good color for the synchronization bits (referred to hereafter as “the good synchronization color”). In an example, the good synchronization color is encoded into the lazy synchronization barrier, stored in a global storage mechanism, stored in a thread-local storage mechanism of the target thread, and/or maintained in some other memory location readily accessible to the target thread. If the synchronization bits of the requested pointer store a bad color or no color, then the requested pointer is stale with respect to the present synchronization process, and the target thread proceeds to Operation 706. In this scenario, the lazy synchronization barrier will direct the target thread to “heal” the pointer. Healing the requested pointer may entail creating a new staged copy of the requested object, remapping the requested pointer to a new staged copy of the requested object, coloring the requested pointer, and/or other operations. Alternatively, if the synchronization bits of the requested pointer store the good synchronization color, then the target thread proceeds to Operation 718. In this alternative scenario, the target thread may assume that both the requested pointer and the requested object have been synchronized during the present synchronization process. Note that the lazy synchronization barrier may also direct the target thread to evaluate the values that are stored to other coloring bits of the requested pointer, and the lazy synchronization barrier may also direct the target thread to perform other operations based on this evaluation. For example, based on the values stored to other coloring bits in the requested pointer, the lazy synchronization barrier may direct the target thread to perform certain garbage collection operations.

In one or more embodiments, the target thread, acting pursuant to the lazy synchronization barrier, determines if the requested pointer should be remapped, and the target thread proceeds to another operation based on this determination (Operation 706). In other words, the target thread determines if the requested pointer currently refers to the appropriate memory location. The requested pointer may, for example, warrant remapping if the requested pointer refers to an unsynchronized stage object rather than a synchronized stage object. In another example, the requested pointer warrants remapping because the requested pointer refers to a memory location where a synchronized object formerly resided before this synchronized object was relocated by a garbage collection cycle. If the target thread determines that the requested pointer should be remapped, then the target thread proceeds to Operation 708. Alternatively, if the target thread determines that the requested pointer does not warrant remapping at this time, then the target thread proceeds to Operation 716.

In one or more embodiments, the target thread, acting pursuant to the lazy synchronization barrier, determines if a new staged copy of the requested object should be created in a staging area of the target thread, and the target thread proceeds to another operation based on this operation (Operation 708). In other words, the target thread is determining if the requested object should be synchronized at this time. If the target thread determines that the requested object is a target object that has not yet been synchronized during the present synchronization process, then the target thread proceeds to Operation 710. In this scenario, the lazy synchronization barrier will direct the target thread to create a new staged copy of the requested object (i.e., a synchronized stage object). Hereafter, the new staged copy of the requested object created through the present synchronization process is referred to as “the new stage object”). Alternatively, if the target thread determines that the requested object is not a target object that should be synchronized at this time, then the target thread proceeds to Operation 714. In this alternative scenario, it may be that the new stage object has already been created during the present synchronization process, or it may be that the requested pointer needs to remap to some other runtime object that already exists in runtime memory.

In one or more embodiments, the target thread, acting pursuant to the lazy synchronization barrier, may perform concurrency check(s) to determine if it is safe to synchronize the requested object, and the target thread may proceed to another operation based on this determination (Operation 710). In other words, the target thread is determining if it is safe to create the new stage object. As noted above, a concurrency check is a check for potential concurrency issues and/or causality bugs. The target thread performs no concurrency checks, a single concurrency check, or multiple concurrency checks. If the lazy synchronization barrier does not direct the target thread to perform a concurrency check, then the target thread proceeds to Operation 712. Similarly, if the target thread fails to identify a potential concurrency issue associated with synchronizing the requested object, then the target thread proceeds to Operation 712. Alternatively, if the target thread does identify a potential concurrency issue associated with synchronizing the requested object, then the target thread proceeds to Operation 720.

In an embodiment, the target thread, acting pursuant to the lazy synchronization barrier, determines if it is safe to synchronize the requested object (i.e., performs a concurrency check) by comparing (a) any mutations that have been applied to a staged copy of the requested object that predates the present synchronization process (i.e., an unsynchronized stage object) to (b) any mutations that have been applied to the corresponding canonical object (i.e., the canonical copy of the requested object). In other words, the target thread is determining if it is safe to create the new stage object. Hereafter, the staged copy of the requested object that predates the present synchronization process is referred to as “the old stage object;” any mutations that have been applied to the old stage object are referred to as “the staged mutations;” the corresponding canonical object is referred to as “the canonical object;” and any mutations that have been applied to the canonical object are referred to as “the canonized mutations.” The target thread performs this comparison to determine if the canonized mutations are compatible (i.e., do not conflict) with any of the staged mutations. In an example, the target thread determines if the canonized mutations are compatible with the staged mutations by comparing (a) the fields of the requested object that have been updated by the canonized mutations with (b) the fields of the requested object that have been updated by the staged mutations. If the fields updated by the canonized mutations do not overlap with the fields updated by the staged mutations, then the target thread may conclude that the canonized mutations are compatible with the staged mutations. Alternatively, if there is at least one field updated by both the canonized mutations and the staged mutations in this example, then the target thread may conclude that the canonized mutations are not compatible with the staged mutations.

In an embodiment, the target thread, acting pursuant to the lazy synchronization barrier, acquires a lock on the canonical object before performing a concurrency check. For example, if the canonical object is a shared object, then the target thread may acquire a lock on the canonical object. Note that acquiring a lock on the canonical object may act as a concurrency check. For example, if the target thread is unable to acquire a lock on the canonical object, then the target thread may assume that another thread is concurrently attempting to manipulate the canonical object in a way that could conflict with the program task.

In one or more embodiments, the target thread, acting pursuant to the lazy synchronization barrier, creates the new stage object (Operation 712). The target thread creates the new stage object by synchronizing the canonized mutations with the staged mutations. While creating the new stage object, the target thread may pull values from the canonical object, the old stage object, and/or another copy of the requested object. The target thread creates the new stage object in a new staging area that has been allocated for the target thread, or the target thread creates the new stage object by updating the old stage object. After creating the new stage object, the target thread may also update a forwarding table to include an entry mapping the new stage object to the old stage object and/or the canonical object. In an example, this entry in the forwarding table specifies a memory location where the new stage object resides.

In one or more embodiments, the target thread, acting pursuant to the lazy synchronization barrier, remaps the requested pointer (Operation 714). For example, if the requested object is a target object, then the target thread remaps the requested pointer to the new stage object by storing the current address of the new stage object to address bits of the requested pointer. The target thread may remap the requested pointer to the new stage object based on an entry in a forwarding table that maps the old stage object to the new stage object.

In one or more embodiments, the target thread, acting pursuant to the lazy synchronization barrier, stores the good synchronization color to the synchronization bits of the requested pointer to indicate that the requested pointer has been confirmed to refer to the correct memory location as part of the present synchronization process (Operation 716). In storing the good synchronization color to the synchronization bits of the requested pointer, the target thread completes the healing of the requested pointer (i.e., the requested pointer is no longer stale with respect to the present synchronization process). In some cases, the target thread may also store other good colors to other coloring bits of the requested pointer.

In one or more embodiments, the target thread, acting pursuant to the lazy synchronization barrier, may update the canonical object to match the state of the new stage object (Operation 720). In other words, the target thread commits the staged mutations to the shared area of runtime memory. Prior to updating the canonical object, the target thread may acquire a lock on the canonical object, and the target thread may release this lock after updating the canonical object. In other embodiments, the system may defer committing the staged mutation to the shared area until a later time, and the target thread may skip this operation.

In one or more embodiments, the lazy synchronization barrier permits the target thread to resume program execution as normal (Operation 720). For instance, the target thread may be permitted to complete the program task requested by the program instance. In this scenario, the lazy synchronization barrier permits the target thread to resume program execution as normal because no potential concurrency issue associated with the program instance's request was uncovered by the target thread while executing the lazy synchronization barrier.

In one or more embodiments, the target thread, acting pursuant to the lazy synchronization barrier, aborts the present synchronization process (Operation 722). In this scenario, the lazy synchronization barrier calls for the termination of the present synchronization process because the target thread uncovered a potential concurrency issue and/or a causality bug associated with synchronizing the canonized mutations and the staged mutations. For example, the target thread may have identified a canonized mutation to a field in a canonical object that conflicts with a staged mutation to that same field in an unsynchronized stage object. Additionally, or alternatively, the lazy synchronization barrier may direct the target thread to perform other corrective actions. Examples of other corrective actions that may be stipulated by the lazy synchronization barrier include preventing or delaying the completion of the program task, alerting a user to the potential concurrency issue and/or causality bug, discarding the unsynchronized stage objects, creating a new staged copy of the canonical objects to replace the unsynchronized stage objects, restarting the program task, terminating the program instance, and others.

In an embodiment, the target thread, acting pursuant to the lazy synchronization barrier, flags a conflict between a canonized mutation and a staged mutation as manifestation of a causality bug in the program instance. The target thread flags this conflict as a manifestation of a causality bug even if this conflict was unlikely to result in any evident concurrency issue. As discussed below, consistently flagging manifestations of causality bugs even where these manifestations are unlikely to cause a concurrency issue may aid in diagnosing this causality bug.

In an embodiment, target thread, acting pursuant to the lazy synchronization barrier, discards the unsynchronized stage objects and creates a new staged copy of the canonical objects. The target thread creates this new staged copy of the canonical objects by copying from the canonical objects. The staged mutations are not applied to this new staged copy of the canonical objects. After creating the new staged copy of the canonical objects, the lazy synchronization barrier instructs the target thread to restart the program task defined in the program instance's request.

### 5. Example Embodiment

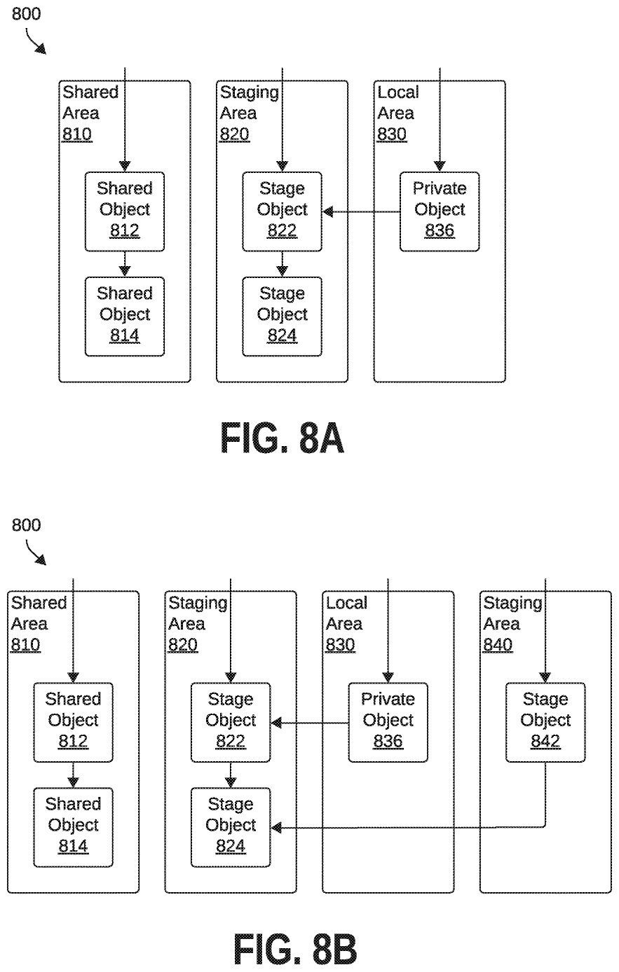

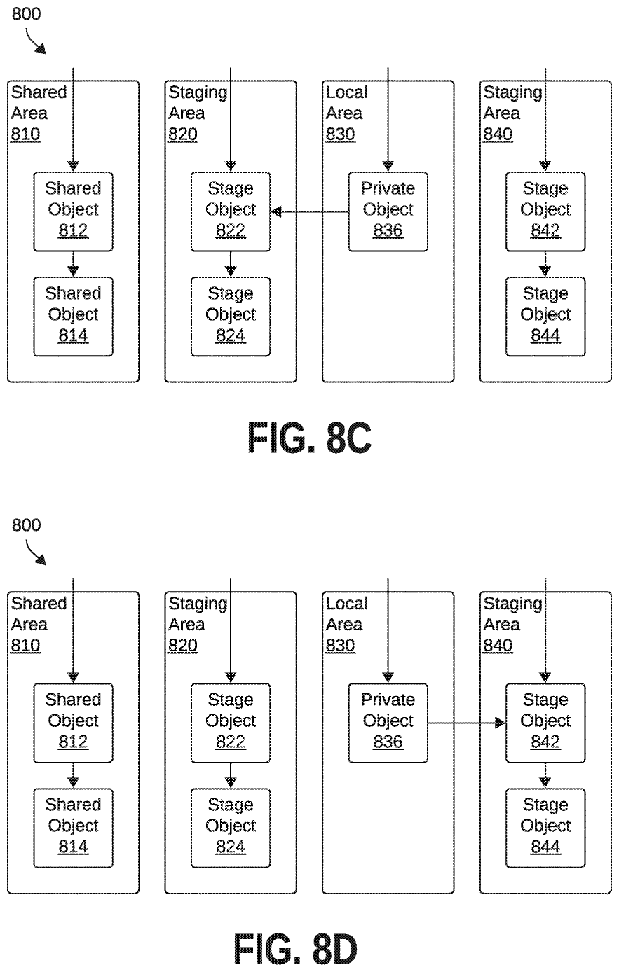

FIG. 8A, FIG. 8B, FIG. 8C, and FIG. 8D illustrate the impact of an example set of operations for synchronizing divergent mutations to copies of a data set in accordance with an example embodiment. A detailed example is described below for purposes of clarity. Components and/or operations described below should be understood as one specific example that may not be applicable to certain embodiments. Accordingly, components and/or operations described below should not be construed as limiting the scope of any of the claims.

In an example embodiment, an initial synchronization barrier is imposed on a program thread in response to a request from a program instance that amounts to a synchronization trigger. Hereafter, the program thread is referred to as “the target thread.” FIG. 8A illustrates the state of runtime memory 800 at the time the initial synchronization barrier is imposed on the target thread in accordance with this example embodiment. As illustrated in FIG. 8A, runtime memory 800 includes a shared area 810, a staging area 820, and a local area 830 of the target thread when the initial synchronization barrier is imposed on the target thread. At this time, shared area 810 includes shared object 812 and shared object 814; staging area 820 includes a staged copy of shared object 812 (i.e., stage object 822) and a staged copy of shared object 814 (i.e., stage object 824); and local area 830 includes a private object 836 of the target thread. Specifically, the initial synchronization barrier is imposed on the target thread in response to the target thread attempting to write to a direct-write field of stage object 822 (i.e., the synchronization trigger). For the purposes of this example, assume that completing this request from the program instance does not involve manipulating any other staged copy of a shared object. The initial synchronization barrier includes executable instructions for initiating a synchronization process that is directed to synchronizing (a) any mutations that have been applied to shared object 812 and shared object 814 with (b) any mutations that have been applied to stage object 822 and stage object 824. Hereafter, the synchronization process that is initiated by the initial synchronization barrier is referred to as “the present synchronization process.”

In an example embodiment, the target thread, acting pursuant to the initial synchronization barrier, defines a new good color for the present synchronization process. As a result, it may be assumed that, at a minimum, the synchronization bits of any given pointer that refers to a stage object in staging area 820 will include a bad color or no color in the instant after the new good color is defined. Hereafter, the new good color for the present synchronization process is referred to as “the good synchronization color.” In this example, the new good color is encoded into the synchronization barriers that will be executed during the present synchronization process and/or stored to another memory location.

In an example embodiment, the target thread, acting pursuant to the initial synchronization barrier, compares any mutations that have been applied to shared object 812 with any mutations that have been applied to stage object 822 to determine if these mutations are compatible. In other words, the target thread is performing a concurrency check to determine if it is safe to create a new stage object that merges these mutations. In this example, the target thread determines there are no conflicting mutations between shared object 812 and stage object 822. Therefore, the target thread may conclude it is safe to create a new stage object that merges these mutations, and the initial synchronization barrier directs the target thread to proceed with the present synchronization process.

In an example embodiment, the target thread, acting pursuant to the initial synchronization barrier, allocates a new staging area for the present synchronization process (i.e., staging area 840), and the target thread creates a new staged copy of shared object 812 in staging area 840 (i.e., stage object 842). The target thread creates stage object 842 by merging any mutations that have been applied to shared object 812 with any mutations that have been applied to stage object 822. Unmutated fields may be copied from either shared object 812 or stage object 822. Note that like stage object 822, stage object 842 includes a field that refers to stage object 824. Since the program task that amounts to the synchronization trigger does not involve loading or writing to the pointer that implements this reference, the target thread simply copies this pointer to stage object 842 without updating the coloring of this pointer. Therefore, the synchronization bits of this pointer as it exists in stage object 842 will retain a bad color after stage object 842 is created in this operation. After creating stage object 842, the target thread creates an entry in a forwarding table that maps stage object 822 to stage object 842.

In an example embodiment, the target thread, acting in accordance with the initial synchronization barrier, attempts to acquire a lock on shared object 812. In this example, the target thread successfully acquires a lock on shared object 812. The successful acquisition of the lock on shared object 812 (a) suggests that another thread is not concurrently attempting to manipulate shared object 812 and (b) ensures that another thread will not mutate shared object 812 until the target thread releases this lock.

In an example embodiment, the target thread, acting pursuant to the initial synchronization barrier, updates the non-direct-write fields of shared object 812 to match the non-direct-write fields of stage object 842. In other words, the target thread is committing any non-volatile mutations that have been applied to stage object 822 to the shared area 810. Furthermore, while updating the shared object 812, the target thread is completing the program task that amounted to the synchronization trigger. Recall that in this example, the initial synchronization barrier was imposed on the target thread in response to the target thread attempting to write a new value to a direct-write field of stage object 822. While updating shared object 812 in this example, the target thread writes this new value to the corresponding direct-write field in shared object 812, thereby completing the program instance's request. After updating shared object 812, the target thread releases the lock on shared object 812, and the target thread is permitted to resume program execution as normal.

In an example embodiment, a first lazy synchronization barrier is imposed on the target thread in response to a request from the program instance. In particular, the first lazy synchronization barrier is imposed on the target thread in response to the target thread attempting to load the pointer that originates from stage object 842 and points to stage object 824. Hereafter, this pointer that originates from stage object 842 and points to stage object 824 is referred to as “the first pointer.” FIG. 8B illustrates the state of runtime memory 800 at the time the first lazy synchronization barrier is imposed on the target thread.

In an example embodiment, the target thread, acting pursuant to the first lazy synchronization barrier, inspects the coloring of the first pointer to determine if this pointer requires healing as part of the present synchronization process. In particular, the target thread compares the value stored in the synchronization bits of the first pointer with the good synchronization color that is encoded into the first lazy synchronization barrier. In this example, the target thread's attempt to load the first pointer is the first attempt to load this pointer since the start of the present synchronization process, and the synchronization bits of this pointer still store a value other than the good synchronization color. In other words, the synchronization bits of the first pointer store a bad color at this time (i.e., the first pointer is stale with respect to the present synchronization process). Therefore, based on this comparison, the target thread concludes that the first pointer should be healed as part of the present synchronization process before program execution is permitted to resume. Hereafter, the first pointer is referred to as “the healed first pointer.”

In an example embodiment, the target thread, acting pursuant to the first lazy synchronization barrier, traverses the first pointer to identify the object referenced by this pointer (i.e., stage object 824), and the target thread cross-references stage object 824 with the forwarding table. In this example, stage object 824 is not represented by any entry in the forwarding table at this time. Therefore, the target thread concludes that any divergent mutations between shared object 814 and stage object 824 have not yet been synchronized by the present synchronization process, and the first lazy synchronization barrier will direct the target thread to synchronize these divergent mutations by creating a new staged copy of shared object 814 and remap the pointer to this new stage object.

In an example embodiment, the target thread, acting pursuant to the first lazy synchronization barrier, compares any mutations that have been applied to shared object 814 with any mutations that have been applied to stage object 824 to determine if these mutations are compatible. In other words, the target thread is performing a concurrency check to determine if it is safe to create a new stage object that merges these mutations. In this example, the target object determines there are no conflicting mutations between shared object 814 and stage object 824. Therefore, the target thread concludes it is safe to create a new stage object that merges these mutations, and the first lazy synchronization barrier directs the target thread to proceed with the present synchronization process.

In an example embodiment, the target thread, acting pursuant to the first lazy synchronization barrier, creates a new staged copy of shared object 814 in staging area 840 (i.e., stage object 844). The target thread creates stage object 844 by merging any mutations that have been applied to shared object 814 with any mutations that have been applied to stage object 824. Unmutated fields are copied from either shared object 814 or stage object 824. After creating stage object 844, the target thread adds an entry to the forwarding table that maps stage object 824 to stage object 844.

In an example embodiment, the target thread, acting pursuant to the first lazy synchronization barrier, remaps the first pointer originating from stage object 842, so this pointer refers to stage object 844 instead of stage object 824; the target thread updates the coloring of the first pointer to indicate that this pointer has been confirmed to refer to the correct memory location as part of the present synchronization process. The target thread may remap the first pointer to stage object 844 based on the mapping between stage object 824 and stage object 844 that is recorded in the forwarding table. The target thread updates the coloring of this pointer by storing the good synchronization color to the synchronization bits of this pointer. In storing the good synchronization color to the synchronization bits of the first pointer, the target thread completes the healing of the first pointer (i.e., the first pointer is no longer stale with respect to the present synchronization process).

In an example embodiment, the target thread, acting pursuant to the first lazy synchronization barrier, attempts to acquire a lock on shared object 814. In this example, the target thread successfully acquires a lock on shared object 814. The successful acquisition of the lock on shared object 814 (a) suggests that another thread is not concurrently attempting to manipulate shared object 814 and (b) ensures that another thread will not mutate shared object 814 until the target thread releases the lock.

In an example embodiment, the target thread, acting pursuant to the first lazy synchronization barrier, updates the fields of shared object 814 to match the fields of stage object 844. In other words, the target thread is committing any mutations that have been applied to stage object 824 to the shared area 810. After updating shared object 814, the target thread releases the lock on shared object 814, and the target thread is permitted to resume program execution as normal.

In an example embodiment, a second lazy synchronization barrier is imposed on the target thread in response to a request from the program instance. In particular, the second lazy synchronization barrier is imposed on the target thread in response to the target thread attempting to load the pointer that originates from private object 836 and refers to stage object 822. Hereafter, this pointer that originates from private object 836 and pointer to stage object 822 is referred to as “the second pointer.” FIG. 8C illustrates the state of runtime memory 800 at the time the second lazy synchronization barrier is imposed on the target thread.

In an example embodiment, the target thread, acting pursuant to the second lazy synchronization barrier, inspects the coloring of the second pointer to determine if this pointer requires healing as part of the present synchronization process. In particular, the target thread compares the value stored in the synchronization bits of the second pointer with the good synchronization color encoded into the lazy synchronization barrier. In this example, the target thread's attempt to load the second pointer is the first attempt to load this pointer since the start of the present synchronization process, and the synchronization bits of this pointer still store a value other than the good synchronization color. In other words, the synchronization bits of the second pointer store a bad color at this time (i.e., the second pointer is stale with respect to the present synchronization process). Therefore, based on this comparison, the target thread concludes that the second pointer should be healed as part of the present synchronization process before program execution is permitted to resume.

In an example embodiment, the target thread, acting pursuant to the second lazy synchronization barrier, traverses the second pointer to identify the object referenced by this pointer (i.e., stage object 822), and the target thread cross-references stage object 822 with the forwarding table. In this example, stage object 822 is mapped to stage object 842 in the forwarding table. Therefore, the target thread concludes that any divergent mutations between shared object 812 and stage object 822 have already been synchronized into stage object 842 as part of the present synchronization process.

In an example embodiment, the target thread, acting pursuant to the second lazy synchronization barrier, remaps the second pointer, so this pointer now refers to stage object 842 instead of stage object 822; the target thread updates the coloring of this pointer, indicating this pointer has been confirmed to refer to the correct memory location as part of the present synchronization process. The target thread may remap the second pointer to stage object 842 based on the mapping between stage object 822 and stage object 844 recorded in the forwarding table. The target thread updates the coloring of the second pointer by storing the good synchronization color to the synchronization bits of this pointer. In storing the good synchronization color to the synchronization bits of the second pointer, the target thread completes the healing of the second pointer (i.e., the second pointer is no longer stale with respect to the present synchronization process).

In an example embodiment, a third lazy synchronization barrier is imposed on the target thread in response to a request from the program instance. In particular, the third lazy synchronization barrier is imposed on the target thread in response to the target thread attempting to load the first healed pointer (i.e., the pointer that originates from stage object 842 and refers to stage object 844). FIG. 8D illustrates the state of runtime memory 800 at the time the third lazy synchronization barrier is imposed on the target thread. At this time, the present synchronization process has fully synchronized the runtime objects and pointers illustrated in FIG. 8D.

In an example embodiment, the target thread, acting pursuant to the third lazy synchronization barrier, inspects the coloring of the first healed pointer to determine if this pointer requires healing as part of the present synchronization process. In particular, the target thread compares the value stored in the synchronization bits of the first healed pointer with the good synchronization color encoded into the third lazy synchronization barrier. At present, the synchronization bits of the first healed pointer store the good synchronization color. Therefore, the target thread concludes that the first healed pointer has already been confirmed to refer to the correct memory location as part of the present synchronization process, and the target thread is permitted to resume program execution as normal.

### 6. Practical Applications, Advantages, and Improvements

Embodiments of the present disclosure provide several practical applications, advantages, and improvements over existing architectures for managing concurrent computing operations. These practical applications, advantages, and improvements include concurrency safety, deterministic failure handling, simplified diagnostics, cost efficiency, backwards compatibility, operational flexibility, and others. As an illustrative example, some of these practical applications, advantages, and improvements are described below in the context of a multi-thread computing environment implemented using at least one object-oriented programming language. However, neither a threaded computing environment nor an object-oriented programming language are essential or necessary to realize these practical applications, advantages, and improvements. By practicing the techniques described herein, these practical applications, advantages, and improvements may be realized in the context of other computing architectures and/or other programming languages.

One or more embodiments prevent concurrency issues by compelling program threads to interact with shared objects indirectly through staged copies of the shared objects created in isolated staging areas. For instance, when a program thread attempts to complete a program task that involves interacting with a shared object at the behest of a program instance, the system may compel the program thread to create a staged copy of this shared object (i.e., a stage object) in an isolated staging area of the program thread. After the stage object is created, the system redirects execution of the program task to operate on the stage object rather than on the shared object. Since the stage object is inaccessible to other threads, the program thread is free to execute the program task on the stage object without risk of another thread's concurrent activities interfering with the program thread's performance of the program task. For example, since the other threads cannot access the stage object, there is no risk of the program thread being insnared in an infinite loop or other concurrency issue that could otherwise arise if another thread was capable of concurrently mutating a field of the stage object that is a basis for performing the program task. When the program thread completes the program task on the stage object, the program thread may be permitted to publish any changes that have been made to the stage object to a shared area of runtime memory by updating the shared object to match the state of the stage object. Prior to committing these changes to the shared area, the system may compel the program thread to check if any other threads have published any conflicting mutations to the shared area since the program thread initially created the stage object in the program thread's staging area. If there are no conflicting mutations, then the system may permit the program thread to publish these changes to the shared area. If there are conflicting mutations, then the system may prevent the program thread from publishing these changes, and the system may compel the program thread to restart the program task with a new staged copy of the shared object and/or perform other corrective actions. By preventing the program thread from publishing the conflicting changes to the shared area, the system prevents potential concurrency issues that might otherwise arise from the uncertainty and inconsistency in the shared area that would result from publishing these conflicting changes.

By staging the performance of program tasks that involve interacting with shared objects in isolated staging areas of runtime memory, one or more embodiments ensure deterministic failure handling and avoid harmful side effects that might otherwise result from partial completions of these program tasks in shared memory. As noted above, the system compels a program thread to perform a program task involving a shared object on a staged copy of the shared object (i.e., a stage object) maintained in an isolated staging area rather than directly on the shared object itself. Upon completion of the program task on the stage object, the program thread may be permitted to commit changes made to the stage object to the shared area if the system determines those changes do not conflict with any intervening updates committed to the shared area by other threads while the program thread was staging the performance of the program task. If a conflict is detected, the system prevents the program thread from committing the changes to the shared area. Since the program task is executed on the stage object in the staging area, no partial or intermediate mutations are applied to the shared object prior to conflict detection. As a result, aborting the commit does not require reversing, compensating for, or rolling back any operations previously performed by the program thread while staging the performance of the program task. This deferred synchronization model ensures deterministic failure handling by allowing failed execution attempts to be discarded without impacting the state of shared memory. After an aborted commit, the program thread can simply restart the program task by obtaining a new staged copy of the shared object and re-executing the task, thereby ensuring correctness while avoiding memory corruption and inconsistent shared state.

One or more embodiments reduce the cost of implementing concurrency safety via staged interactions with shared data structures by lazily synchronizing any changes made to separate copies of the shared data structures and coloring pointers to track the progression of this synchronization process. For instance, in the course of a synchronization process, the system may refrain from directing a program thread to synchronize any changes made to a shared object with any changes made to a staged copy of this shared object (i.e., a stage object) until if and when a new synchronized copy of the shared object is currently needed to continue program execution. By directing a program thread to lazily synchronize changes in this manner, the system reduces the amount of work done by the program thread to implement concurrency safety via staged interactions with shared data structures. Minimizing the amount of work done by a program thread to implement concurrency safety via staged interactions with shared data structures reduces the impact that concurrency safety has on program performance. The system compels the program thread to stage these interactions via barriers inserted into the executable instructions of a program instance being executed by the program thread. To keep track of what runtime objects and references have been lazily synchronized during a synchronization process, the system directs the program thread to color pointers while staging interactions with shared objects. For instance, when the program thread attempts to load a pointer that refers to a stage object at the behest of a program instance, the system may impose a barrier on the program thread that directs the program thread to consult the coloring of the pointer to determine if this pointer and/or this stage object have been synchronized as part of the ongoing synchronization process. Since the information needed to make this determination is encoded into the pointer that the program thread is already loading at the behest of the program instance and/or the barrier that is directly inserted into the executable instructions of the program instance, this determination can be made by the program thread with minimal computational cost and disruption to program execution. Considering these barriers that may be inserted into the executable instructions of the program instance for any given load operation and/or write operation, this reduction in computational cost and disruption to program execution may be highly significant for rendering concurrency safety via staged interactions feasible in production environments.

By staging the performance of program tasks that involve interacting with shared objects in isolated staging areas of runtime memory, one or more embodiments reduce the cost of implementing concurrency safety. As noted above, the system compels a program thread to perform a program task involving a shared object on a staged copy of the shared object (i.e., a stage object) maintained in an isolated staging area rather than operating directly on the shared object itself. Staging the performance of the program task in this manner allows the program thread to perform the program task optimistically. In particular, the program thread is free to perform the program task without having to coordinate the program thread's activities with the concurrent activities of the other threads. As a result, the cost that would otherwise be incurred by the program thread in coordinating with other threads while completing the program task is avoided. Upon completion of the program task on the stage object, the program thread may be permitted to commit changes made to the stage object to the shared area if these changes do not conflict with any intervening updates committed to the shared area by other threads while the program thread was staging the performance of the program task. Staging the performance of the program task in this manner will result in a cost savings unless the changes made to the staged object conflict with other changes that have been published to the shared area. If such conflicts do exist, then the system may direct the program thread to restart the program task with a new staged copy of the shared object, and the cost of restarting the program task might outweigh the cost savings associated with optimistically performing the program task. However, such conflicts are generally uncommon. Therefore, on aggregate, the cost savings from optimistically performing program tasks will typically outweigh the cost incurred by restarting program tasks due to conflicts.

One or more embodiments simplify diagnosing a causality bug in a program instance by detecting and flagging manifestations of a causality bug even where these manifestations do not necessarily result in externally observable incorrect behavior. Note that a manifestation of a causality bug, such as conflicting mutations to the same memory location, does not necessarily spawn an evident concurrency issue. If the benign manifestations of a causality bug are not detected, a causality bug can appear to a developer as manifesting itself infrequently and at random. Diagnosing this causality bug based on these seemingly sporadic manifestations can be difficult and time consuming. However, by compelling program threads to check for conflicting mutations at any given synchronization attempt between a shared area of runtime memory and a staging area of runtime memory, the system detects conflicting mutations that result from a causality bug even where there conflicting mutations do not result in a concurrency issue or are prevented from causing a concurrency issue by the system. By flagging these conflicting mutations to a developer as manifestations of a causality bug regardless of whether or not these conflicts spawn a concurrency issue, the system may significantly simplify the identification and diagnosis of the causality bug.

By staging the performance of program tasks that involve interacting with shared objects in isolated staging areas of runtime memory, one or more embodiments may reduce reliance on locks during program execution. While a program thread is performing a program task on a staged copy of a shared object (i.e., a stage object) in an isolated staging area, the program thread need not acquire a lock on the stage object because the stage object is inaccessible to other threads. Acquisition of a lock on the shared object may be deferred to a singular occasion where the state of the shared object is updated to match the state of the stage object following the completion of the program task. In contrast, maintaining concurrency safety while performing this same program task directly on the shared object instead of the staged object might involve acquiring and releasing a lock on the shared object on multiple occasions throughout the performance of the program task. Accordingly, staging the performance of the program task may significantly reduce the program thread's reliance on locks while actively executing program tasks. By reducing reliance on locks while actively performing program tasks, the system may avoid lock convoying, mitigate priority inversion, prevent deadlocks, reduce the time that is spent in kernel-level synchronization, and/or otherwise alleviate performance and correctness challenges commonly associated with greater reliance on locks.

One or more embodiments allow for the implementation of concurrency safety via staged interactions with shared data structures in a wide range of computing environments by implementing these staged interactions in a manner that is backwards compatible with programs that predate the techniques described herein. In other words, the techniques disclosed herein can be used to provide concurrency safety via staged interaction during runtime of legacy programs without developers having to make alterations to the executable instructions of these legacy programs. The techniques described herein for concurrency safety are made retroactively applicable to legacy programs using barriers that define logic for staging interactions. Before and/or during program execution, the system is configured to automatically insert these barriers into the executable instructions of a program instance where the barrier logic may be needed to perform the various tasks that facilitate staging interactions. With limited cost to program performance, these barriers may be used to perform any number of a wide variety of tasks that facilitate concurrency safety via staged interactions, such as the creation of stage objects, redirection of program tasks from shared objects to staged objects, checks for concurrency issues and/or causality bugs, acquisition of locks on shared objects, synchronization of shared objects with staged objects, remapping of pointers, coloring of pointers, garbage collection, and/or other functions. By allowing for concurrency safety via staged interactions to be applied retroactively to preexisting programs, the applicability of the techniques described herein may be greatly increased.

One or more embodiments provide operational flexibility in implementing concurrency safety via staged interactions. For instance, a user may enable or disable the features used to implement concurrency safety via staged interactions in whole or in part. As a result, a user can enable concurrency safety via staged interactions in production environments where concurrency safety is prioritized over small reductions in program performance, and the user can disable concurrency safety via staged interactions in production environments where small increases in program performance are prioritized over concurrency safety. Additionally, or alternatively, the system may permit fine-grain configuration of concurrency safety via staged interactions at a task-specific level. For example, during development or maintenance of a program, a developer may trigger the staging of interactions for one program task by defining this program task using one token, and the user may circumvent the staging of interactions for another program task by defining this other program task using another token. As a result, a user can choose to implement concurrency safety via staged interactions for program tasks that warrant prioritizing concurrency safety over program performance, and the user can choose to bypass the implementation of concurrency safety via staged interactions for program tasks that warrant prioritizing program performance over concurrency safety.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

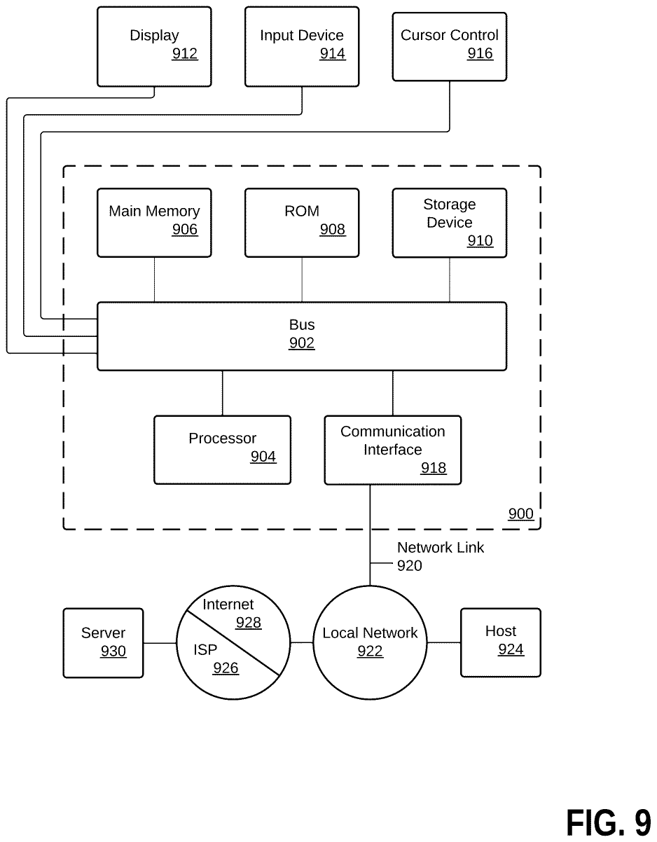

For example, FIG. 9 is a block diagram that illustrates a computer system 900 upon which an embodiment of the disclosure may be implemented. Computer system 900 includes a bus 902 or other communication mechanism for communicating information, and a hardware processor 904 coupled with bus 902 for processing information. Hardware processor 904 may be, for example, a general-purpose microprocessor.

Computer system 900 also includes a main memory 906, such as a random access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read-only memory (ROM) 908 or other static storage device coupled to bus 902 for storing static information and instructions for processor 904. A storage device 910, such as a magnetic disk or optical disk, is provided and coupled to bus 902 for storing information and instructions.

Computer system 900 may be coupled via bus 902 to a display 912, such as a cathode ray tube (CRT), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor 904 executing one or more sequences of one or more instructions included in main memory 906. Such instructions may be read into main memory 906 from another storage medium, such as storage device 910. Execution of the sequences of instructions included in main memory 906 causes processor 904 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 910. Volatile media includes dynamic memory, such as main memory 906. Common forms of storage media include, for example, a floppy disk, a flexible disk, hard disk, solid-state drive (SSD), magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or SSD of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes a communication interface 918 coupled to bus 902. Communication interface 918 provides a two-way data communication coupling to a network link 920 that is connected to a local network 922. For example, communication interface 918 may be an integrated services digital network (ISDN) card, cable modem, satellite modem, or a modem to provide a data communication connection to a corresponding type of telephone line. As another example, communication interface 918 may be a local area network (LAN) card to provide a data communication connection to a compatible LAN. Wireless links may also be implemented. In any such implementation, communication interface 918 sends and receives electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the world wide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918.

The received code may be executed by processor 904 as it is received, and/or stored in storage device 910, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, a computer program product includes instructions that, when executed by one or more hardware processors, causes performance of any of the operations described herein and/or recited in any of the claims.

In an embodiment, one or more non-transitory computer-readable storage media store instructions that, when executed by one or more hardware processors, cause performance of any of the operations described herein and/or recited in any of the claims. As used herein, the term “non-transitory computer-readable medium” refers to any tangible storage medium that stores computer-executable instructions for execution by one or more hardware processors in a computing device(s). The term “non-transitory” excludes transitory, propagating signals per se, such as carrier waves or other electromagnetic signals, but includes all forms of physical storage media.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
performing a first part of a synchronization process for two or more copies of a set of runtime objects, the set of runtime objects comprising a first object and a second object, wherein performing the first part of the synchronization process comprises:
generating a copy of the first object, the copy of the first object comprising a first pointer to a first copy of the second object;
subsequent to performing the first part of the synchronization process and responsive to a program instance requesting performance of a program task targeting the second object, performing a second part of the synchronization process, wherein performing the second part of the synchronization process comprises:
decoding a first set of one or more bits in the first pointer that are not allocated for addressing a memory location, the first set of one or more bits comprising a first value indicating that the first pointer has not been updated during the synchronization process;
based at least in part on the first set of one or more bits comprising the first value, determining that the first copy of the second object was not created during the synchronization process;
responsive to determining that the first copy of the second object was not created during the synchronization process, generating a second copy of the second object; and
subsequent to performing the second part of the synchronization process, performing the program task targeting the second object, wherein performing the program task targeting the second object comprises accessing the second copy of the second object,
wherein the method is performed by at least one device including a hardware processor.

2. The method of claim 1:
wherein performing the first part of the synchronization process further comprises defining a second value for tracking the synchronization process;
wherein determining that the first copy of the second object was not created during the synchronization process comprises:
based at least in part on comparing the first value in the first set of one or more bits in the first pointer to the second value for tracking the synchronization process, determining that the first set of one or more bits does not comprise the second value; and
wherein performing the second part of the synchronization process further comprises:
remapping the first pointer to the second copy of the second object, wherein remapping the first pointer comprises updating a second set of address bits in the first pointer to comprise an address of the second copy of the second object; and
updating the first set of one or more bits in the first pointer to indicate that the first pointer has been updated during the synchronization process, wherein updating the first set of one or more bits comprises storing the second value in the first set of one or more bits.

3. The method of claim 2:
wherein performing the first part of the synchronization process further comprises encoding the second value into a barrier comprising instructions for performing at least part of the synchronization process;
wherein the barrier is imposed on a first thread that is executing the program instance at least in part;
wherein the barrier is imposed on the first thread responsive to the program instance requesting performance of the program task targeting the second object by the first thread; and
wherein the second part of the synchronization process is performed by the first thread while executing the instructions comprised in the barrier.

4. The method of claim 2, further comprising:
subsequent to performing the second part of the synchronization process and responsive to a request to a thread from the program instance to load the first pointer:
decoding, by the thread, the first set of one or more bits in the first pointer to determine if the first pointer has been updated during the synchronization process;
based at least in part on the first set of one or more bits in the first pointer comprising the second value, determining, by the thread, that the first pointer has been updated during the synchronization process; and
responsive to determining that the first pointer has been updating during the synchronization process, completing, by the thread, the request from the program instance to load the first pointer.

5. The method of claim 1:
wherein a plurality of threads are executing the program instance;
wherein the plurality of threads comprises a first thread and a second thread;
wherein the first copy of the first object is accessible to the first thread;
wherein the first copy of the first object is not accessible to the second thread;
wherein generating the second copy of the second object comprises copying a value from at least one of: (a) the first copy of the first object or (b) a third copy of the second object that is accessible to the plurality of threads.

6. The method of claim 5, wherein performing the second part of the synchronization process further comprises:
based at least in part on comparing (a) a first set of one or more mutations to the first copy of the second object to (b) a second set of one or more mutations to the third copy of the second object, determining if the first set of one or more mutations are compatible with the second set of one or more mutations; and
based at least in part on determining that the first set of one or more mutations are compatible with the second set of one or more mutations:
applying the first set of one or more mutations to the third copy of the second object.

7. The method of claim 1, further comprising:
responsive to the program instance requesting performance of a program task targeting a third object comprised within the set of runtime objects:
based at least in part on comparing (a) a first set of one or more mutations to a first copy of the third object that is accessible to a first thread and inaccessible to a second thread to (b) a second set of one or more mutations to a second copy of the third object that is accessible to a plurality of threads comprising the first thread and the second thread, determining, by the first thread, that the first set of one or more mutations conflict with the second set of one or more mutations; and
responsive to determining that the first set of one or more mutations conflict with the second set of one or more mutations, preventing or delaying the performance of the program task targeting the third object.

8. The method of claim 1:
wherein performing the first part of the synchronization process is responsive to the program instance requesting performance of a program task targeting the first object by a thread that is executing the program instance, at least in part;
wherein the thread performs the first part of the synchronization process;
wherein the thread generates the copy of the first object while performing the first part of the synchronization process based at least in part on determining that performing the program task targeting the first object comprises accessing the copy of the first object; and
wherein the thread does not generate the second copy of the second object while performing the first part of the synchronization process based at least in part on determining that performing the program task targeting the first object does not comprise accessing the second copy of the second object.

9. The method of claim 1:
wherein the program instance is being executed by a plurality of threads, the plurality of threads comprising a first thread and a second thread;
wherein the first thread performs the first part of the synchronization process responsive to the program instance requesting a mutation to a particular direct-write field of the first object by the first thread;
wherein generating the copy of the first object comprises copying a value from at least one of: (a) an isolated copy of the first object that is inaccessible to the second thread or (b) a shared copy of the first object that is accessible to the plurality of threads; and
wherein performing the first part of the synchronization process further comprises mutating the particular direct-write field in the shared copy of the first object.

10. One or more non-transitory computer-readable media storing program instructions that, when executed by one or more hardware processors, cause performance of operations comprising:
performing a first part of a synchronization process for two or more copies of a set of runtime objects, the set of runtime objects comprising a first object and a second object, wherein performing the first part of the synchronization process comprises:
generating a copy of the first object, the copy of the first object comprising a first pointer to a first copy of the second object;
subsequent to performing the first part of the synchronization process and responsive to a program instance requesting performance of a program task targeting the second object, performing a second part of the synchronization process, wherein performing the second part of the synchronization process comprises:
decoding a first set of one or more bits in the first pointer that are not allocated for addressing a memory location, the first set of one or more bits comprising a first value indicating that the first pointer has not been updated during the synchronization process;
based at least in part on the first set of one or more bits comprising the first value, determining that the first copy of the second object was not created during the synchronization process;
responsive to determining that the first copy of the second object was not created during the synchronization process, generating a second copy of the second object; and
subsequent to performing the second part of the synchronization process, performing the program task targeting the second object, wherein performing the program task targeting the second object comprises accessing the second copy of the second object.

11. The one or more non-transitory computer-readable media of claim 10:
wherein performing the first part of the synchronization process further comprises defining a second value for tracking the synchronization process;
wherein determining that the first copy of the second object was not created during the synchronization process comprises:
based at least in part on comparing the first value in the first set of one or more bits in the first pointer to the second value for tracking the synchronization process, determining that the first set of one or more bits does not comprise the second value; and
wherein performing the second part of the synchronization process further comprises:
remapping the first pointer to the second copy of the second object, wherein remapping the first pointer comprises updating a second set of address bits in the first pointer to comprise an address of the second copy of the second object; and
updating the first set of one or more bits in the first pointer to indicate that the first pointer has been updated during the synchronization process, wherein updating the first set of one or more bits comprises storing the second value in the first set of one or more bits.

12. The one or more non-transitory computer-readable media of claim 11:
wherein performing the first part of the synchronization process further comprises encoding the second value into a barrier comprising instructions for performing at least part of the synchronization process;
wherein the barrier is imposed on a first thread that is executing the program instance at least in part;
wherein the barrier is imposed on the first thread responsive to the program instance requesting performance of the program task targeting the second object by the first thread; and
wherein the second part of the synchronization process is performed by the first thread while executing the instructions comprised in the barrier.

13. The one or more non-transitory computer-readable media of claim 11, wherein the operations further comprise:
subsequent to performing the second part of the synchronization process and responsive to a request to a thread from the program instance to load the first pointer:
decoding, by the thread, the first set of one or more bits in the first pointer to determine if the first pointer has been updated during the synchronization process;
based at least in part on the first set of one or more bits in the first pointer comprising the second value, determining, by the thread, that the first pointer has been updated during the synchronization process; and
responsive to determining that the first pointer has been updating during the synchronization process, completing, by the thread, the request from the program instance to load the first pointer.

14. The one or more non-transitory computer-readable media of claim 10:
wherein a plurality of threads are executing the program instance;
wherein the plurality of threads comprises a first thread and a second thread;
wherein the first copy of the first object is accessible to the first thread;
wherein the first copy of the first object is not accessible to the second thread;
wherein generating the second copy of the second object comprises copying a value from at least one of: (a) the first copy of the first object or (b) a third copy of the second object that is accessible to the plurality of threads.

15. The one or more non-transitory computer-readable media of claim 14, wherein performing the second part of the synchronization process further comprises:
based at least in part on comparing (a) a first set of one or more mutations to the first copy of the second object to (b) a second set of one or more mutations to the third copy of the second object, determining if the first set of one or more mutations are compatible with the second set of one or more mutations; and
based at least in part on determining that the first set of one or more mutations are compatible with the second set of one or more mutations:
applying the first set of one or more mutations to the third copy of the second object.

16. The one or more non-transitory computer-readable media of claim 15, wherein the operations further comprise:
responsive to the program instance requesting performance of a program task targeting a third object comprised within the set of runtime objects:
based at least in part on comparing (a) a first set of one or more mutations to a first copy of the third object that is accessible to a first thread and inaccessible to a second thread to (b) a second set of one or more mutations to a second copy of the third object that is accessible to a plurality of threads comprising the first thread and the second thread, determining, by the first thread, that the first set of one or more mutations conflict with the second set of one or more mutations; and
responsive to determining that the first set of one or more mutations conflict with the second set of one or more mutations, preventing or delaying the performance of the program task targeting the third object.

17. The one or more non-transitory computer-readable media of claim 10:
wherein performing the first part of the synchronization process is responsive to the program instance requesting performance of a program task targeting the first object by a thread that is executing the program instance, at least in part;
wherein the thread performs the first part of the synchronization process;
wherein the thread generates the copy of the first object while performing the first part of the synchronization process based at least in part on determining that performing the program task targeting the first object comprises accessing the copy of the first object; and
wherein the thread does not generate the second copy of the second object while performing the first part of the synchronization process based at least in part on determining that performing the program task targeting the first object does not comprise accessing the second copy of the second object.

18. The one or more non-transitory computer-readable media of claim 10:
wherein the program instance is being executed by a plurality of threads, the plurality of threads comprising a first thread and a second thread;
wherein the first thread performs the first part of the synchronization process responsive to the program instance requesting a mutation to a particular direct-write field of the first object by the first thread;
wherein generating the copy of the first object comprises copying a value from at least one of: (a) an isolated copy of the first object that is inaccessible to the second thread or (b) a shared copy of the first object that is accessible to the plurality of threads; and
wherein performing the first part of the synchronization process further comprises mutating the particular direct-write field in the shared copy of the first object.

19. A system comprising:
one or more hardware processors;
one or more non-transitory computer-readable media; and
program instructions stored on the one or more non-transitory computer-readable media that, when executed by the one or more hardware processors, cause the system to perform operations comprising:
performing a first part of a synchronization process for two or more copies of a set of runtime objects, the set of runtime objects comprising a first object and a second object, wherein performing the first part of the synchronization process comprises:
generating a copy of the first object, the copy of the first object comprising a first pointer to a first copy of the second object;
subsequent to performing the first part of the synchronization process and responsive to a program instance requesting performance of a program task targeting the second object, performing a second part of the synchronization process, wherein performing the second part of the synchronization process comprises:
decoding a first set of one or more bits in the first pointer that are not allocated for addressing a memory location, the first set of one or more bits comprising a first value indicating that the first pointer has not been updated during the synchronization process;
based at least in part on the first set of one or more bits comprising the first value, determining that the first copy of the second object was not created during the synchronization process;
responsive to determining that the first copy of the second object was not created during the synchronization process, generating a second copy of the second object; and
subsequent to performing the second part of the synchronization process, performing the program task targeting the second object, wherein performing the program task targeting the second object comprises accessing the second copy of the second object.

20. The system of claim 19:
wherein performing the first part of the synchronization process further comprises defining a second value for tracking the synchronization process;
wherein determining that the first copy of the second object was not created during the synchronization process comprises:
based at least in part on comparing the first value in the first set of one or more bits in the first pointer to the second value for tracking the synchronization process, determining that the first set of one or more bits does not comprise the second value; and
wherein performing the second part of the synchronization process further comprises:
remapping the first pointer to the second copy of the second object, wherein remapping the first pointer comprises updating a second set of address bits in the first pointer to comprise an address of the second copy of the second object; and
updating the first set of one or more bits in the first pointer to indicate that the first pointer has been updated during the synchronization process, wherein updating the first set of one or more bits comprises storing the second value in the first set of one or more bits.
